(19) United States
(12) Patent Application Publication
(10) Pub. No.: US 2008/0162323 A1
(43) Pub. Date: Jul. 3, 2008

(54) System and Method for Providing Online Education

(76) Inventors: Steven Menear, Marietta, GA (US); Caroline McMillan, Statesboro, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/983,653

(22) Filed: Nov. 8, 2007

Related U.S. Application Data
(60) Provisional application No. 60/857,682, filed on Nov. 8, 2006.
(60) Provisional application No. 60/986,529, filed on Nov. 8, 2007.

(51) Int. Cl. G06Q 99/00

(52) U.S. Cl. 705/35; 705/1

(57) ABSTRACT

A system and method for creating and offering online courses and classes provides a computer program accessible over a computer network. The program includes a template for creating a course by assigning predefined attributes and/or parameters, and by adding lessons, activities, and/or material in conformance with predetermined rules. A selected course is converted into a class for offering over the system which may be archived or deleted after the term. New classes may subsequently be made from the original course. Included are translation and/or conversion functions, wherein inputs and outputs may be translated between human languages and/or converted between different analog and digital forms, and a payment system wherein fees may be charged for access to the system, a course, and/or a class.

### PRIORITY CLAIM TO RELATED APPLICATIONS

The present Patent Cooperation Treaty application is related to, and hereby claims priority to, and the full benefit of, United States provisional application entitled “Multimedia Learning Environment That Supports Online Courses and Classes,” filed Nov. 8, 2006 on behalf of Steven Menear and Caroline McMillan, having assigned Ser. No. 60/857,682, incorporated herein by reference; United States provisional application entitled “Adaptable, Efficient Host Environment For Online Education,” filed Nov. 8, 2007 on behalf of Steven Menear and Caroline McMillan, having assigned Ser. No. 60/986,529, incorporated herein by reference; and United States nonprovisional application entitled “System and Method For Providing Online Education” filed Nov. 8, 2007 on behalf of Steven Menear and Caroline McMillan.

Be it known that I, Steven Menear, a citizen of the United Kingdom, and I, Caroline McMillan, a citizen of the United States of America, have invented new and useful improvements in a SYSTEM AND METHOD FOR PROVIDING ONLINE EDUCATION of which the following comprises the specification.

### TECHNICAL FIELD

The present invention relates generally to online education, and, more particularly, to a system and method for creating online courses and offering online classes.

### BACKGROUND OF THE INVENTION

Online learning has become a popular alternative to the traditional on-site classroom. Many benefits of online education are well known, and include allowing remote participation, real-time and discussion board communication formats, access to archived discussions and lectures, among others. Unfortunately, however, the systems necessary for enabling such beneficial features become increasingly complex with the addition of various features.

For example, it may be necessary for administrators, instructors, and students to each have interactive access to the system, including privileges to add, delete, and/or modify content. Such overlapping permissions create the potential for errors or other problems in the system. One way that this problem has been addressed is by using controls. Any such controls, however, reduce the flexibility of the system, such as by preventing changes to a class while it is progress, or by preventing activities from one class being imported to another class.

Furthermore, in current practice, the allocation of privileges, and the attendant responsibilities and options, varies greatly from one educational institution to another, as well as within an institution, or within a course, from one class offering to the next. Such variance detracts from a user's experience by distracting, confusing, and/or frustrating the user when a course function, layout, options, requirements, or other standard differs from that of a previous class, or from that of another class taken simultaneously. Uniformity in the types of material presented, the types of work expected from the user, the format for presentation, the mechanics of using the system, and the like, would allow users to be more efficient, would avoid confusion and frustration.

Another disadvantage of current systems is their dependence on traditional electronic network communication formats, as well as traditional billing and payment methods. Thus, users are limited to conventional educational payment arrangements, which preclude users from taking advantage of many potential benefits of online education. As a result, users may never enroll, or may discontinue classes due to payment issues.

Likewise, users are limited in the types of communication offered in conventional online classes for lectures or other instruction, as well as being limited in the available formats for discussion, submission of work, and the like. Specifically, text communication is the most common form of communication, which makes accessing course information difficult without a traditional desktop or laptop personal computer. Text-based communication also fails to take full advantage of the richness of other media formats, such as audio and/or video communication. As a result, users may become disinterested, or miscommunication may result.

As such, it is clear that there is an unmet need for an online educational system and method that enables effective and efficient use in the creation, delivery, and participation in online education.

### BRIEF SUMMARY OF THE INVENTION

Briefly described, in a preferred embodiment, the present invention overcomes the above-mentioned disadvantages and meets the recognized need for such a system and method by providing a computer program in the form of a website, accessible over a network. The program includes templates for creating a course by assigning one or more predefined attributes and/or parameters, and by adding lessons, activities, and or material to the course in conformance with predetermined rules associated with the program and/or one or more assigned attribute(s). The program further provides for conversion of a selected course into a class that may be offered over the system by assignment of scheduling information and participant information. Optionally, the conversion may additionally involve the addition of material and/or the customization of one or more lesson and/or activity by assigning one or more predefined attribute to the lesson and/or activity.

Additionally, the program includes translation and/or conversion functions wherein inputs and outputs may be translated between human languages and/or converted between different analog and digital forms. Preferably the program provides computerized translation between human languages, as well as file-type conversion, and/or audio/graphic/text conversion (i.e. text-to-speech, and the like).

The program further provides a payment system wherein fees may be charged for access to the system, for access to a course, and/or for access to a class. The payment system is preferably based on electronic tokens which may be transferred as a form of currency or credit. An operator of the system may collect tokens, or any other desired form of payment, for selected access/services. Preferably a charge is associated with offering a class, and is chargeable to the organization or individual offering the class. The charge is preferably calculated periodically, such as daily, and is preferably determined as a function of a number of students enrolled in all classes associated with a user, such as by a flat per-student charge each day. The system further preferably allows for the creation of relationships between individuals or organizations to create virtual organizations for the purpose of billing and payment, as well as for the purpose of class offerings and knowledge dissemination.

Accordingly, one feature and advantage of the present invention is its ability to simplify the process for course creation, class creation, and/or class offering via predetermined rules governing the design process.

Another feature and advantage of the present invention is its ability to improve efficiency in class creation, offering, and administration via increasing uniformity in course design.

Yet another feature and advantage of the present invention is its ability to allow flexible billing and payment options and/or arrangements to increase access to online education.

These and other features and advantages of the present invention will become more apparent to those ordinarily skilled in the art after reading the following Detailed Description of the Invention and Claims in light of the accompanying drawing Figures.

### BRIEF DESCRIPTION OF THE DRAWINGS

Accordingly, the present invention will be understood best through consideration of, and with reference to, the following drawing Figures, viewed in conjunction with the Detailed Description of the Invention referring thereto, in which like reference numbers throughout the various Figures designate like structure, and in which:

FIG. 1 is a diagram of a system for online education according to the present invention;

FIG. 2 is a screen-shot of a graphical user interface provided by a preferred embodiment of the system for user login;

FIG. 3 is a screen-shot of a graphical user interface provided by a preferred embodiment of the system in response to a failed login attempt;

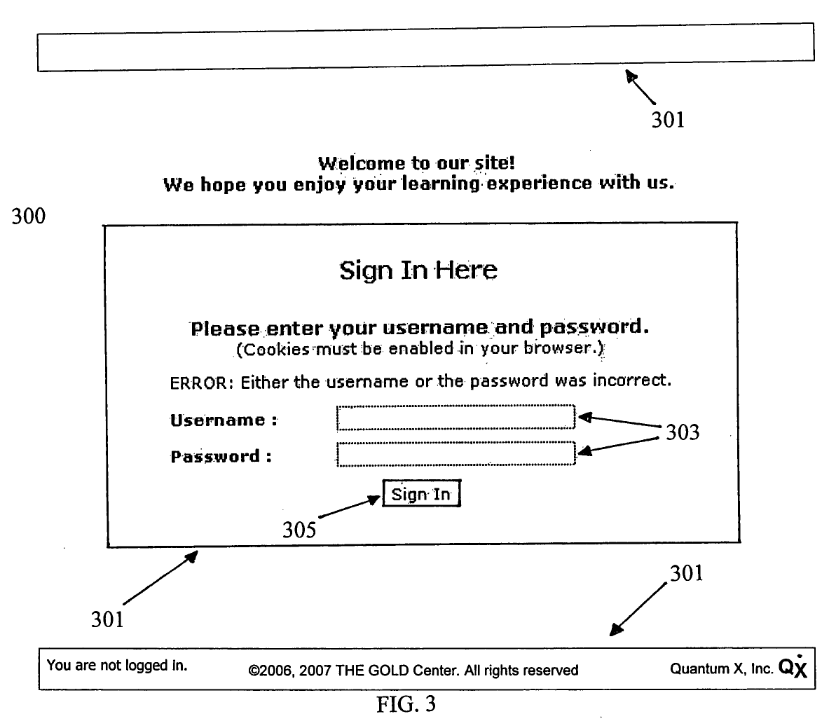

FIG. 4 is a screen-shot of a graphical user interface provided by a preferred embodiment of the system displaying roles available to a user;

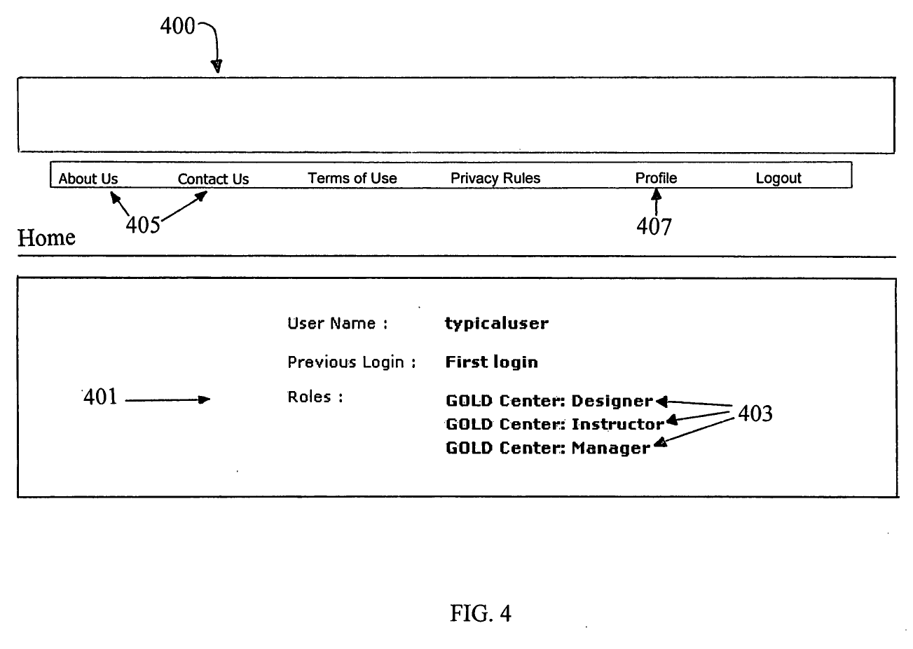

FIG. 5 is a screen-shot of a graphical user interface provided by a preferred embodiment of the system for obtaining user consent to terms of use;

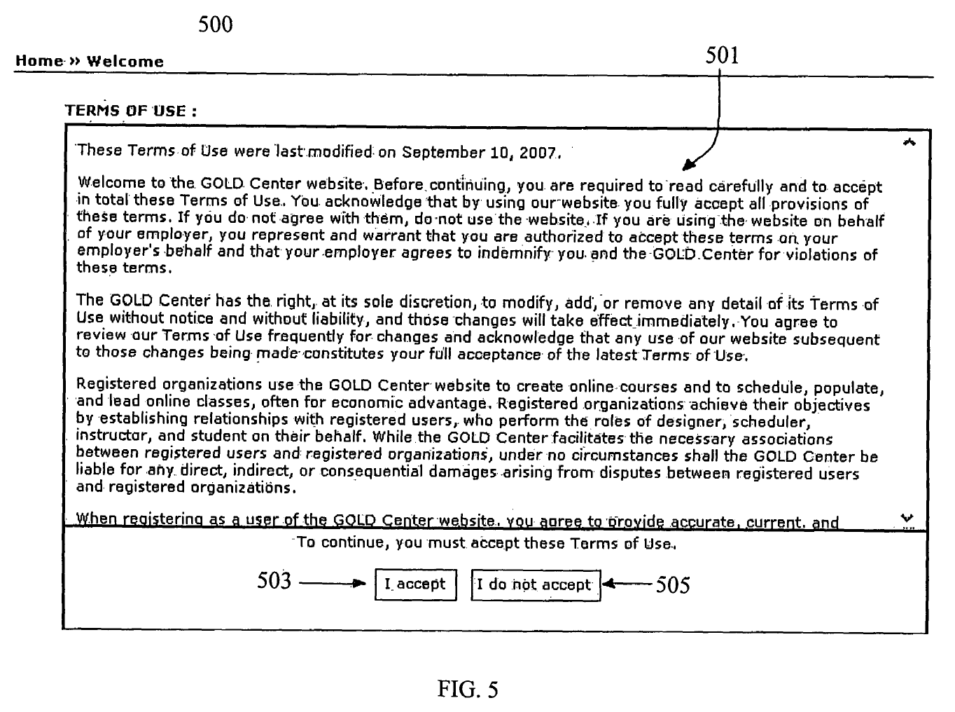

FIG. 6 is a screen-shot of a graphical user interface provided by a preferred embodiment of the system providing a list of courses available to a designer;

FIG. 7 is a screen-shot of a graphical user interface provided by a preferred embodiment of the system for displaying and editing user profile information;

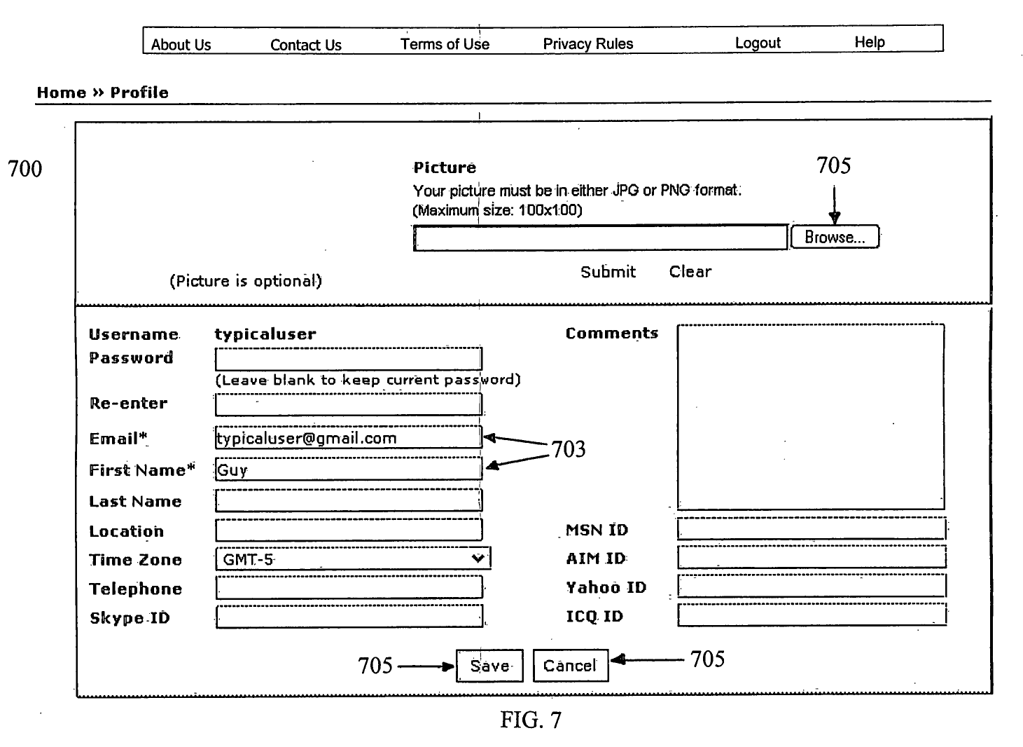

FIG. 8 is a screen-shot of a graphical user interface provided by a preferred embodiment of the system for accessing a newly-created course;

FIG. 9 is a screen-shot of a graphical user interface provided by a preferred embodiment of the system for accessing a duplicate of an existing course;

FIG. 10 is a screen-shot of a graphical user interface provided by a preferred embodiment of the system for confirming the deletion of a course;

FIG. 11 is a screen-shot of a graphical user interface provided by a preferred embodiment of the system for notifying a designer that the status of a course cannot be changed due to the presence of at least one error;

FIG. 12 is a screen-shot of a graphical user interface provided by a preferred embodiment of the system displaying the contents of a selected course;

FIG. 13 is a screen-shot of a graphical user interface provided by a preferred embodiment of the system for warning the user of the effect of changing the attributes of a course;

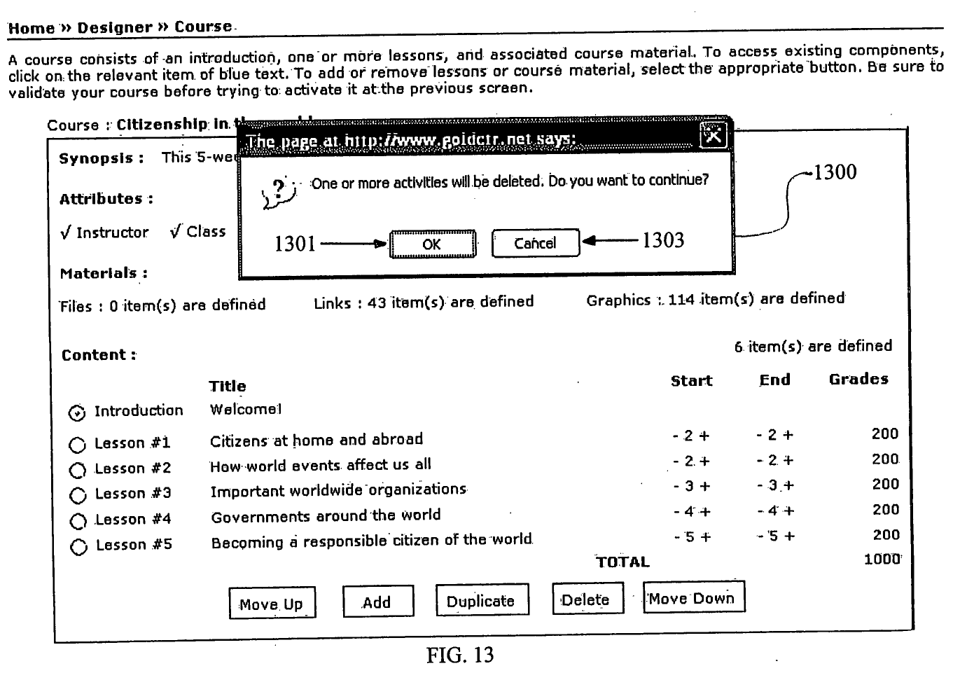

FIG. 14 is a screen-shot of a graphical user interface provided by a preferred embodiment of the system for associating Internet links with a course;

FIG. 15 is a screen-shot of a graphical user interface provided by a preferred embodiment of the system displaying the contents of an introduction of a course;

FIG. 16 is a screen-shot of a graphical user interface provided by a preferred embodiment of the system for editing an introduction of a course;

FIG. 17 is a screen-shot of a graphical user interface provided by a preferred embodiment of the system for editing an instructor forum;

FIG. 18 is a screen-shot of a graphical user interface provided by a preferred embodiment of the system for editing a class forum;

FIG. 19 is a screen-shot of a graphical user interface provided by a preferred embodiment of the system for editing a team forum;

FIG. 20 is a screen-shot of a graphical user interface provided by a preferred embodiment of the system for editing a lesson of a course;

FIG. 21 is a screen-shot of a graphical user interface provided by a preferred embodiment of the system for editing a graded forum of a lesson;

FIG. 22 is a screen-shot of a graphical user interface provided by a preferred embodiment of the system for editing a message of a forum;

FIG. 23 is a screen-shot of a graphical user interface provided by a preferred embodiment of the system displaying the contents of an assignment of a lesson;

FIG. 24 is a screen-shot of a graphical user interface provided by a preferred embodiment of the system for editing an assignment of a lesson;

FIG. 25 is a screen-shot of a graphical user interface provided by a preferred embodiment of the system displaying the content of a review project;

FIG. 26 is a screen-shot of a graphical user interface provided by a preferred embodiment of the system for editing the contents of a review project;

FIG. 27 is a screen-shot of a graphical user interface provided by a preferred embodiment of the system displaying the contents of a team project;

FIG. 28 is a screen-shot of a graphical User interface provided by a preferred embodiment of the system for editing a team project;

FIG. 29 is a screen-shot of a graphical user interface provided by a preferred embodiment of the system displaying a summary of the contents of a quiz;

FIG. 30 is a screen-shot of a graphical user interface provided by a preferred embodiment of the system for editing a quiz;

FIG. 31 is a screen-shot of a graphical user interface provided by a preferred embodiment of the system for editing the attributes of a quiz;

FIG. 32 is a screen-shot of a graphical user interface provided by a preferred embodiment of the system displaying the questions of a quiz;

FIG. 33 is a screen-shot of a graphical user interface provided by a preferred embodiment of the system searching quiz questions;

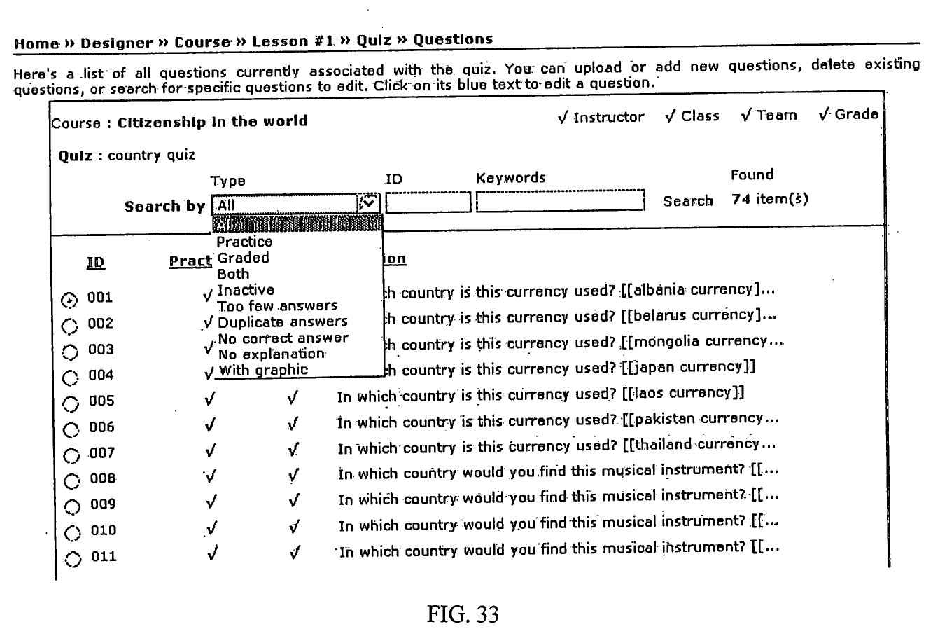

FIG. 34 is a screen-shot of a graphical user interface provided by a preferred embodiment of the system displaying the contents of a quiz question;

FIG. 35 is a screen-shot of a graphical user interface provided by a preferred embodiment of the system for editing a quiz question;

FIG. 36 is a screen-shot of a graphical user interface provided by a preferred embodiment of the system for editing an explanation of an answer choice of a quiz question;

FIG. 37 is a screen-shot of a graphical user interface provided by a preferred embodiment of the system for editing an answer choice of a quiz question;

FIG. 38 is a screen-shot of a graphical user interface provided by a preferred embodiment of the system displaying the contents of an assessment of a lesson;

FIG. 39 is a screen-shot of a graphical user interface provided by a preferred embodiment of the system for editing a summary of an assessment;

FIG. 40 is a screen-shot of a graphical user interface provided by a preferred embodiment of the system for editing the attributes of an assessment;

FIG. 41 is a screen-shot of a graphical user interface provided by a preferred embodiment of the system displaying the tasks of an assessment;

FIG. 42 is a screen-shot of a graphical user interface provided by a preferred embodiment of the system for editing a task of an assessment;

FIG. 43 is a screen-shot of a graphical user interface provided by a preferred embodiment of the system displaying the results of a course validation;

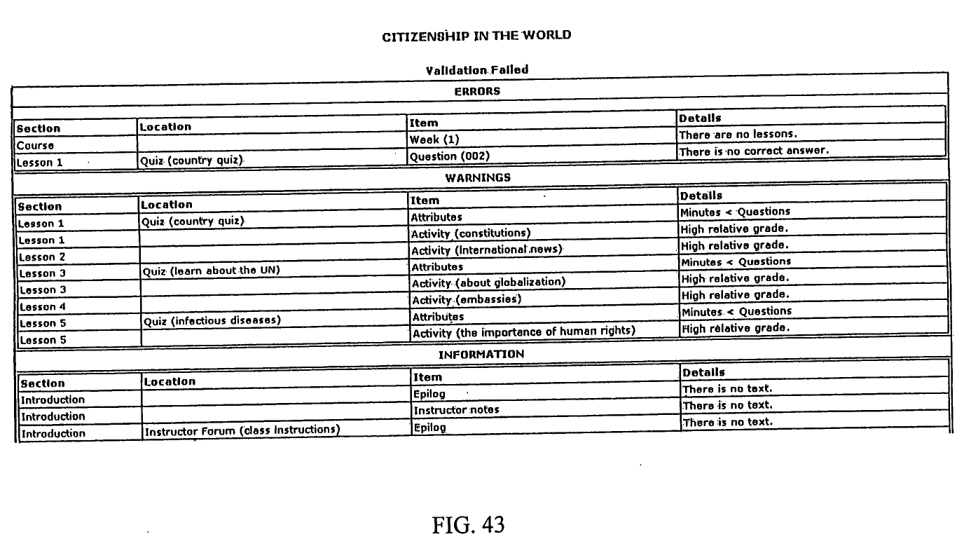

FIG. 44 is a screen-shot of a graphical user interface provided by a preferred embodiment of the system displaying activities available for a course without a team attribute;

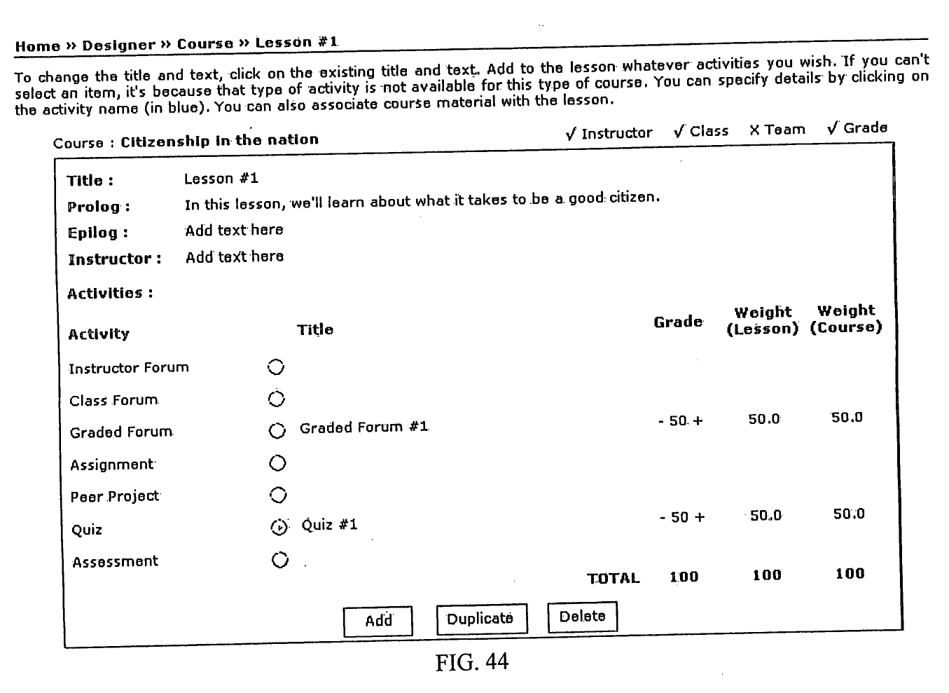

FIG. 45 is a screen-shot of a graphical user interface provided by a preferred embodiment of the system displaying activities available for a course with no attributes assigned;

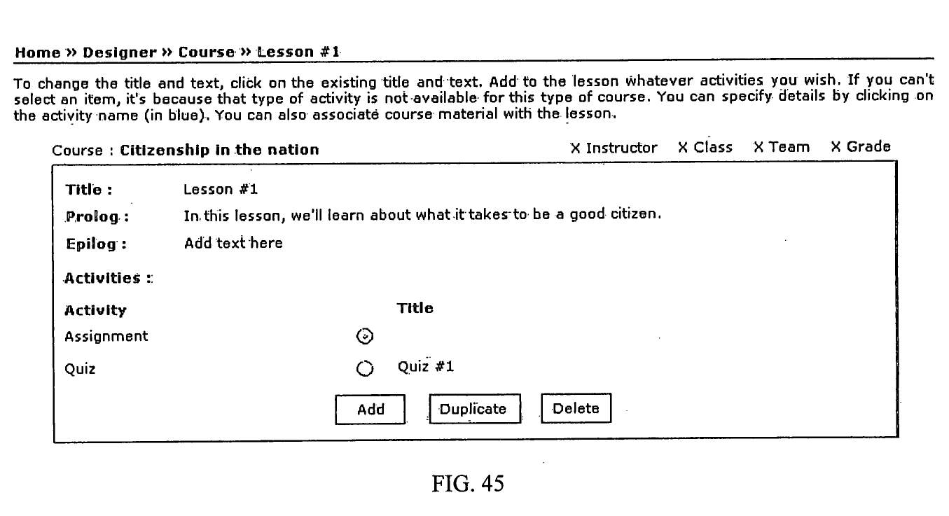

FIG. 46 is a screen-shot of a graphical user interface provided by a preferred embodiment of the system for creating a new class;

FIG. 47 is a screen-shot of a graphical user interface provided by a preferred embodiment of the system for adjusting the default schedule when creating a new class;

FIG. 48 is a screen-shot of a graphical user interface provided by a preferred embodiment of the system for adjusting maximum grades when creating a new class;

FIG. 49 is a screen-shot of a graphical user interface provided by a preferred embodiment of the system for editing students enrolled in a class;

FIG. 50 is a screen-shot of a graphical user interface provided by a preferred embodiment of the system for students to choose their own teams;

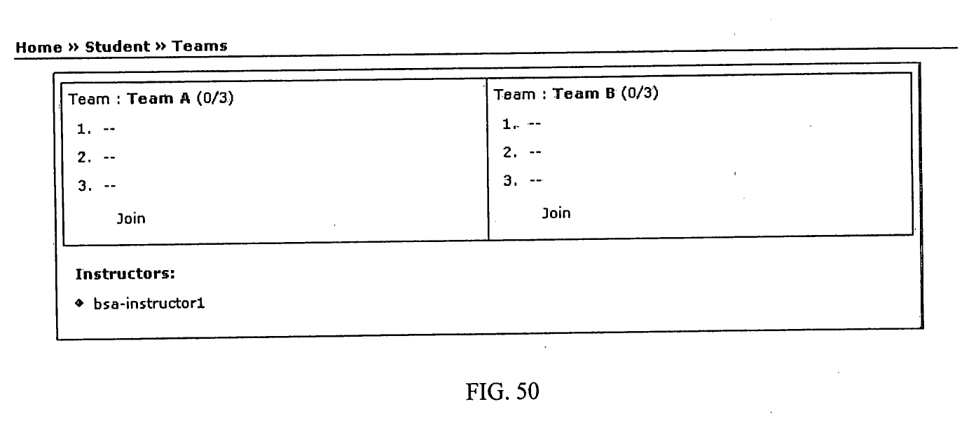

FIG. 51 is a screen-shot of a graphical user interface provided by a preferred embodiment of the system displaying a lesson of a class;

FIG. 52 is a screen-shot of a graphical user interface provided by a preferred embodiment of the system displaying a discussion forum;

FIG. 53 is a screen-shot of a graphical user interface provided by a preferred embodiment of the system displaying an assignment;

FIG. 54 is a screen-shot of a graphical user interface provided by a preferred embodiment of the system displaying a quiz;

FIG. 55 is a screen-shot of a graphical user interface provided by a preferred embodiment of the system displaying a quiz attempt;

FIG. 56 is a screen-shot of a graphical user interface provided by a preferred embodiment of the system for re-entering a quiz attempt;

FIG. 57 is a screen-shot of a graphical user interface provided by a preferred embodiment of the system for assessing the relative contribution of teammates;

FIG. 58 is a screen-shot of a graphical user interface provided by a preferred embodiment of the system displaying an assessment;

FIG. 59 is a screen-shot of a graphical user interface provided by a preferred embodiment of the system for viewing and editing a schedule of activities of a class;

FIG. 60 is a screen-shot of a graphical user interface provided by a preferred embodiment of the system for viewing and editing grades for activities of a class for a selected student;

FIG. 61 is a screen-shot of a graphical user interface provided by a preferred embodiment of the system displaying the grades of all students of a selected class;

FIG. 62 is a diagram illustrating the relationships among users, their roles, and their associations;

FIG. 63 is a diagram illustrating course creation, class creation, and class offering;

FIG. 64 is a diagram illustrating an exemplary structure of a course;

FIG. 65 is a diagram illustrating a menu of activities;

FIG. 66 is a diagram illustrating the creation of a quiz master, creation of a quiz instance, and use of the quiz instance;

FIG. 67 is a diagram illustrating attributes of a quiz;

FIG. 68 is a diagram illustrating attributes of an assessment activity;

FIG. 69 is a diagram illustrating attributes of a communication forum;

FIG. 70 is a diagram illustrating creation of a communication forum master, creation of a communication forum instance, and use of the communication forum instance;

FIG. 71 is a diagram illustrating translation functions of a communication forum;

FIG. 72 is a diagram illustrating possible payment interactions associated with the system;

FIG. 73 is a diagram of a system for hosting online education; and

FIG. 74 is a flow-chart illustrating a method of providing online education.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

The present Patent Cooperation Treaty application is related to, and hereby claims priority to, and the full benefit of, United States provisional application entitled “Multimedia Learning Environment That Supports Online Courses and Classes,” filed Nov. 8, 2006 on behalf of Steven Menear and Caroline McMillan, having assigned Ser. No. 60/857,682, incorporated herein by reference; United States provisional application entitled “Adaptable, Efficient Host Environment For Online Education,” filed Nov. 8, 2007 on behalf of Steven Menear and Caroline McMillan, having assigned Ser. No. 60/986,529, incorporated herein by reference; and United States nonprovisional application entitled “System and Method For Providing Online Education” filed Nov. 8, 2007 on behalf of Steven Menear and Caroline McMillan.

In describing preferred embodiments of the present invention illustrated in the figures, specific terminology is employed for the sake of clarity. The invention, however, is not intended to be limited to the specific terminology so selected, and it is to be understood that each specific element includes all technical equivalents that operate in a similar manner to accomplish a similar purpose.

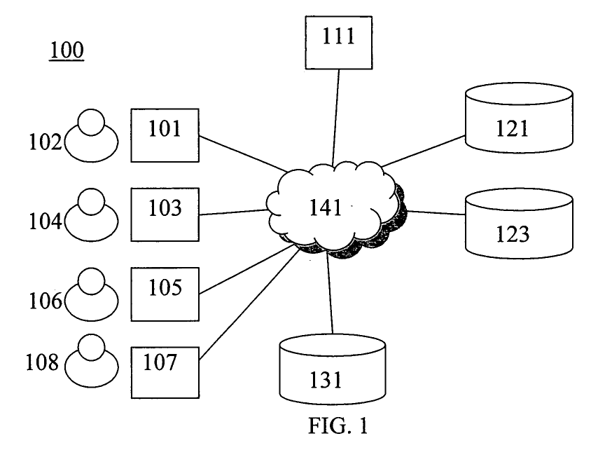

In that form of the preferred embodiment of the present invention chosen for purposes of illustration, FIG. 1 shows system 100 comprising designer terminal 101, manager terminal 103, instructor terminal 105, student terminal 107, host 111, course database 121, class database 123, and payment database 131, connected via network 141. Each of designer terminal 101, manager terminal 103, instructor terminal 105, and student terminal 107 is formed as an appropriate communication device, such as a desktop computer, a laptop computer, a cellular phone, a personal digital assistant (PDA), a satellite device, a land-based phone, a dedicated terminal, or the like. Accordingly, network 141 may comprise a wired network, a wireless network, the Internet, a satellite network, combinations thereof, or the like. In combination with a respective one of designer terminal 101, manager terminal 103, instructor terminal 105, and student terminal 107, network 141 allows designer 102, manager 104, instructor 106, and student 108 to access host 111, course database 121, class database 123, and payment database 131.

Host 111 may take the form of a computer program product stored on a computer-readable storage medium of a remote server computer, or may be stored locally on any or each of designer terminal 101, manager terminal 103, instructor terminal 105, and student terminal 107. Similarly, each of course database 121, class database 123, and payment database 131 may be stored on a the same storage medium, or on respective separate storage media, of one or more dedicated remote server computer(s), or each or any of designer terminal 101, manager terminal 103, instructor terminal 105, and student terminal 107.

Preferably, host 111 comprises a dedicated remote server computer, or system of computers, including each of course database 121, class database 123, and payment database 131 stored on storage media thereof. Host 111 is preferably accessible over the Internet via various pages of a website, as described in greater detail hereinbelow, and preferably receives inputs from one or more of designer 102, manager 104, instructor 106, and student 108 and provides outputs in response thereto. It will be understood by those ordinarily skilled in the art, however, that each of the functions described below corresponding to each of designer terminal 101, manager terminal 103, instructor terminal 105, student terminal 107, host 111, course database 121, class database 123, and payment database 131 may be carried out by a respective independent device or system of devices, such as those operated by independent organizations.

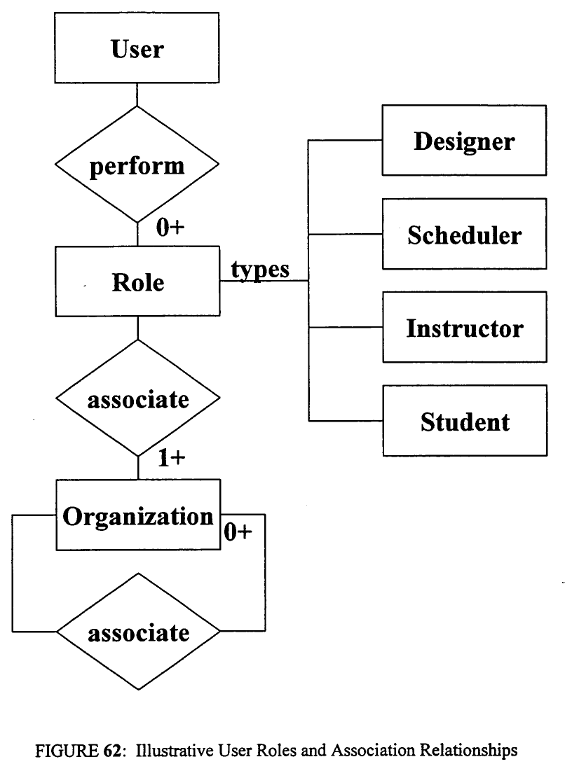

System 100 preferably separates the role of designer 102, manager 104, instructor 106, and student 108 by assigning each function or feature of system 100 to a selected role, and by allowing access a particular function or feature only to those users being assigned to the corresponding role (such as illustrated, for example, in FIG. 62). System 100 preferably further distinguishes between courses and classes, wherein courses define as a shell including one or more lesson(s), activity(ies), and/or material, and wherein classes are defined as a course to which specific student information, scheduling information, class content, or other information has been added. Preferably, only scheduling information is required to create a class, wherein student information may be added during or after an enrollment process.

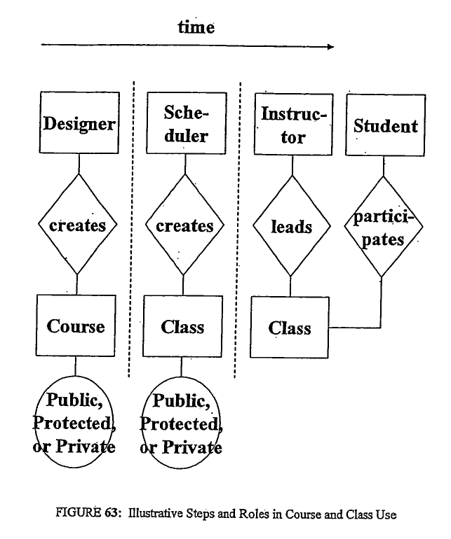

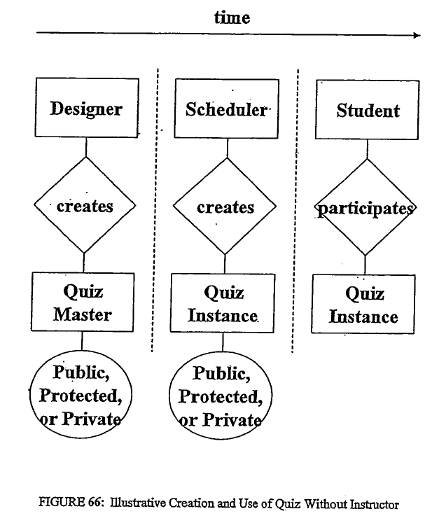

As illustrated, for example, in FIGS. 63 and 66, each course is preferably created by designer 102 according to a predefined template. The template includes a set of permissions, including, for example, permission to include a given type of lesson and/or activity in the course, and includes a predetermined layout. The layout dictates the format of a display provided to a user, whereby the designer need not create the layout, and whereby uniformity of the layout throughout each course (at least those courses associated with a particular organization, unit, level, package, or the like) may avoid user confusion. The particular set of permissions applied to the creation and/or modification of a given course, however, is not static, and preferably depends on a selected set of attributes assigned to the course. The attributes preferably include an instructor attribute, a class attribute, a team attribute, and a grade attribute. While the permissions applied to the creation and/or modification of a course are not static, the schema by which the permissions are changed is preferably static. Such a static permission changing schema not only ensures uniformity of design of each course, but also ensures that the logic associated with the inclusion or exclusion of particular activities within a lesson is consistent based on predetermined criteria and choices.

Specifically, the type of course to be created is preferably a driving choice in the permission setting process for a given course. Thus, if a course is intended to be a “self-study” course, then only a few types of activities may be included, regardless of the number of lessons or the duration of the course. For example, since it would not make sense to have a communication forum in a self-study class, then no communication fora (forums) are permitted for a self-study course (which may be defined by de-selecting or un-assigning all attributes). Likewise, if a “directed study” course in desired, then only activities pertinent for a course involving a single student and an instructor may be included. Thus, the schema of system 100 prevents team activities or peer-review activities from being included in a directed study course. Illustrative types of courses include “self-study”, involving only a student, “directed study”, involving only a single student and an instructor, a “multi-student class”, involving more than one student, an instructor, and grading, a “team class”, involving groups of students, an instructor, and grading, “group self-study” involving more than one student but no instructor and no grading, combinations thereof, and the like.

The desired type of course to be created is preferably defined by the assignment of one or more attribute, as appropriate. For example, as discussed above, assignment of no attributes preferably indicates that a “self-study” course is being created, and the schema of system 100 preferably ensures that only logical activity choices are available. As another example, and not by way of limitation, a “team study”, involving groups of students, no instructor, and no grading, may be defined by assignment of a team attribute, but non-assignment of each of an instructor attribute and a grade attribute.

The instructor attribute designates that an instructor, such as instructor 106, is necessary for a class based on the course. Selection of the instructor attribute for a course preferably allows instructor forums, subjectively-graded activities, or the like, to be included within the course and/or within a lesson thereof. The class attribute designates that more than one student must be enrolled in a class and that the students must be visible to one another. Selection of this attribute for a course preferably allows peer-review activities to be included, as well as allowing the team attribute to be selected. The team attribute designates that multiple students will be assigned, at least temporarily, to teams, and allows team activities to be included. The grade attribute designates that at least one aspect of the course will be graded, and allows graded activities with objective and/or subjective grades to be associated with each student, either overall for the class, or associated with a specific activity. As will be understood by those ordinarily skilled in the art, additional or different attributes may be assigned to each course to designate an associated characteristic of the course, and additional or different permissions may be associated with a given attribute. Thus, each attribute preferably comprises a designer decision, the result of which affects the availability of one or more type of activity, as discussed in greater detail below.

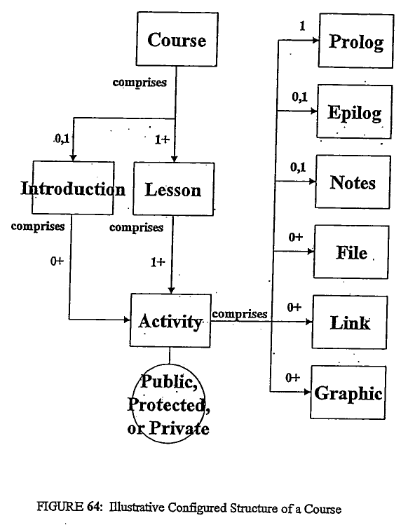

Each course may include one or more lesson, each of which may include one or more activity, and may include material(s) for use with one or more lessons(s) and/or activity(ies), depending on the preference of designer 102, and depending on the selected attribute(s) assigned to the course. By way of example, and not limitation, lessons may be either persistent, i.e. they are accessible at all times during a class, such as an introductory lesson, and may include one or more activity(ies), or, alternatively, lessons may be limited in duration. Designer 102 preferably selects whether a particular lesson is persistent or not, and a duration if not, but does not designate an actual start and/or end date or time for the availability of the particular lesson. One exemplary illustration of such course design choices is shown in FIG. 64.

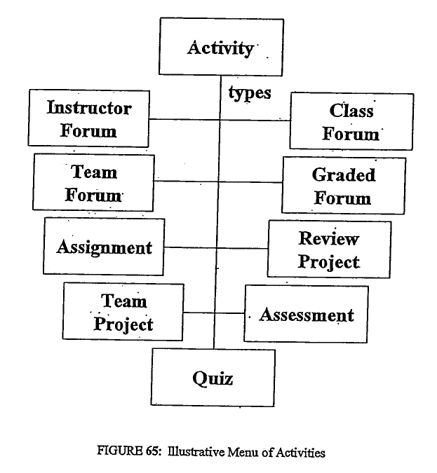

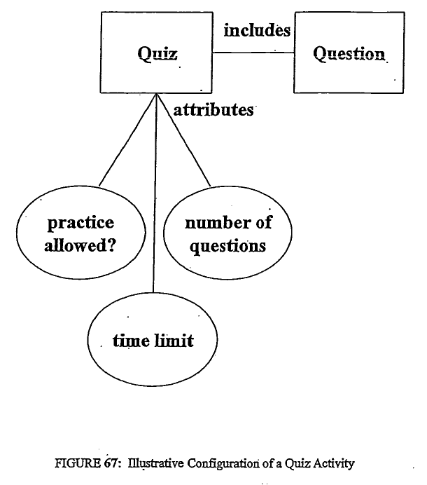

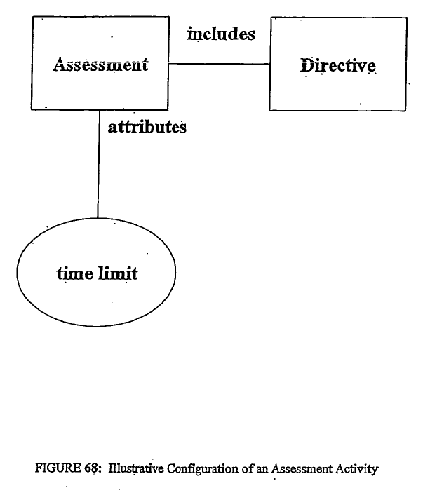

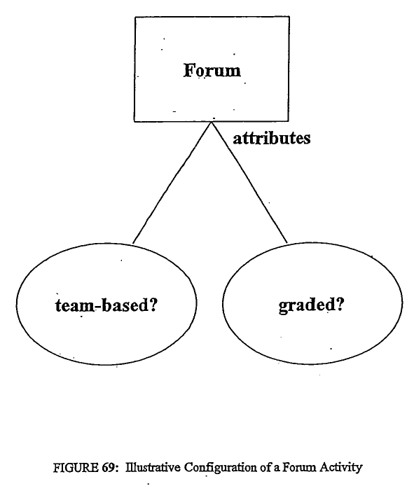

Also by way of example, and not limitation, and with reference, for example, to FIG. 65, activities may be selected from the group including discussion fora (or forums), such as an instructor forum, a class forum, a team forum, or a graded forum, assignments, such as a task, an individual assignment, a team assignment, and a peer assignment, and evaluation activities, such as a quiz or an assessment, or the like. Each activity additionally includes associated parameters that may be selected, de-selected, or adjusted to customize the activity for the particular course or class as desired. See, for example, FIGS. 67-69 for exemplary illustrations of the relationship between activity, and one or more predefined attribute/parameter. Thus system 100 offers adequate flexibility in course and class creation, while restricting the number and type of activities available to a designer to a manageable number.

More specifically, an instructor forum may allow instructor 106, or other user, to post one or more message(s) to the class. Optional attributes of the instructor forum include whether or not students are permitted to add messages or reply to a message, whether attachments and/or links are allowed in messages, and whether one or more message is posted and/or removed automatically at a predetermined time. Preferably, however, the instructor forum serves as a broadcast area where only the instructor may post messages.

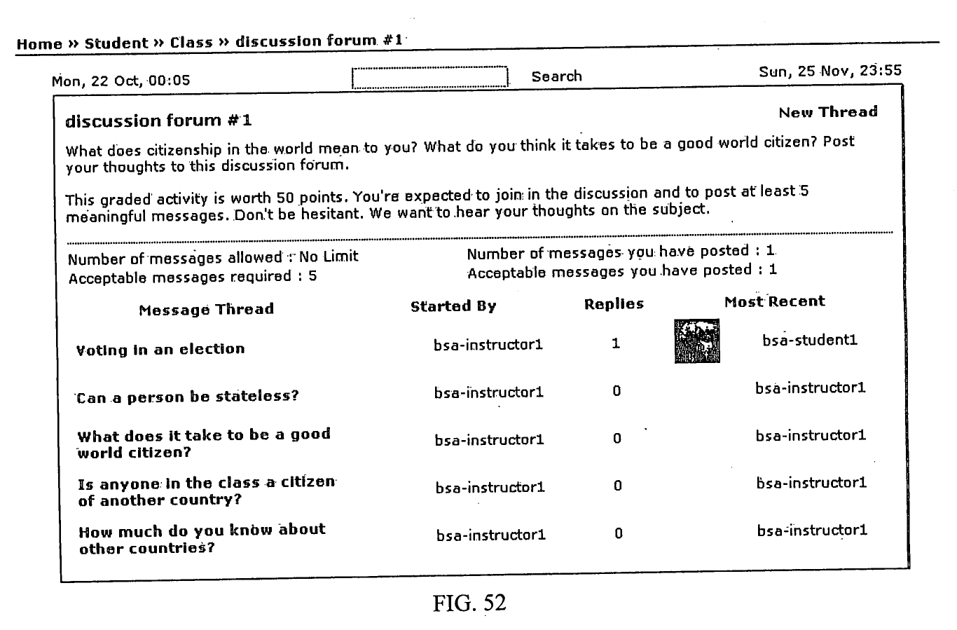

A class forum may allow students to post messages to other students and/or to an instructor, as shown from the student perspective in FIG. 52, and may optionally include parameters such as a minimum posting requirement, a maximum posting cap, permission to add attachments and/or links, an ability to hide messages or restrict access thereto, an ability to add and/or remove a message automatically at a predetermined time, a message size limit, an ability to use an alias, whether a grade is to be assessed, or the like. Preferably, a class forum allows postings by students and the instructor, allows anonymous postings or postings under an alias. The alias feature preferably enables and/or encourages role-playing and/or controversial or personal comments, postings, work product, or the like, that may otherwise not be shared, such as to stimulate meaningful discussions and/or interactions.

A team forum may allow members of a team to post a message to one or more other team member(s), such as to facilitate completion of a team project. Optional parameters of a team forum include whether other students have permission to view and/or post to the forum, whether an instructor may view and/or post to the forum, whether attachments and/or links are permitted, whether a grade will be assessed, whether a minimum or maximum number of postings is defined, or the like. Preferably, a team forum may be viewed only by team members and the instructor.

A graded forum may allow students to post messages for review and grading by the instructor. The messages may be in response to a topic posted by the instructor or are part of the course design, or may relate to new topics. Optional parameters of the graded forum may include whether the postings can be viewed by other students, whether messages must be posted before or after a specified date, whether messages may be modified, whether a minimum or maximum number of postings is specified, or the like. Thus, a graded forum may be formed as a class forum or a team forum, or may be an individual forum specific to the student, in the form of a journal or the like. Each graded forum preferably includes a minimum number of postings and a maximum number of postings. The grading is preferably done by the instructor via a binary or toggle parameter associated with each posting, wherein the instructor may determine, based on selected objective and/or subjective criteria, whether a posting is acceptable or unacceptable. If the posting is acceptable, i.e. the binary value is “1”, then it preferably counts toward the designated minimum number of postings. Thus, the system may preferably determine automatically the number of acceptable postings, and may preferably generate a grade automatically based, for example, on a comparison with the designated minimum. Accordingly, the system may simplify and expedite student evaluation.

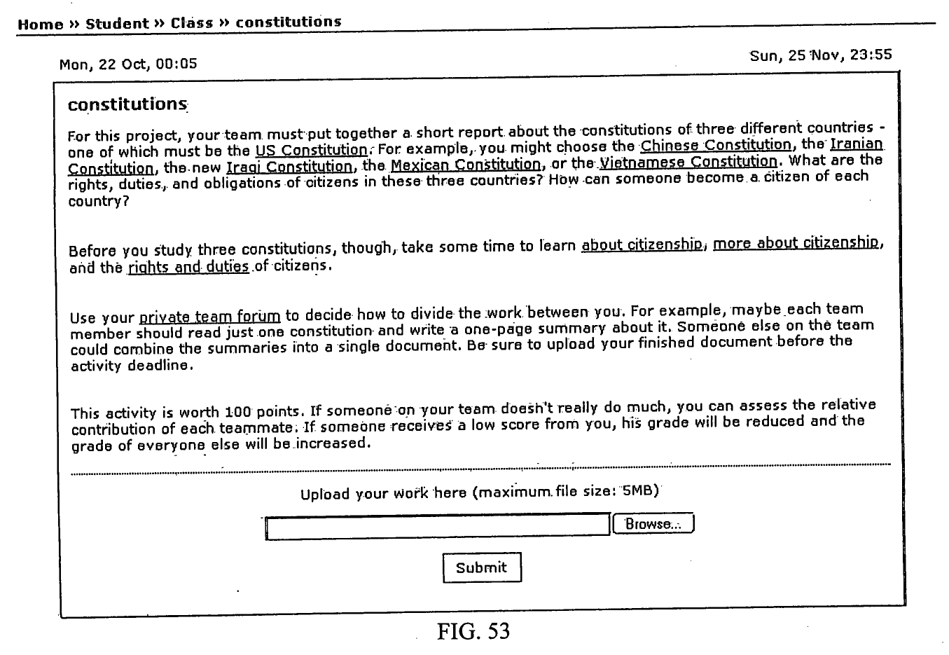

Assignment activities, or projects, whether individual assignments, a peer assignment, a team assignment, and/or a graded assignment, allow an instructor to require the student(s) to perform some task, and may, likewise, have optional parameters. For example, assignment parameters may include whether submitted work may be viewed by other students, whether a time limit or deadline is involved, whether the assignment is graded, whether each individual must submit work or whether a group may submit work as a team, or the like. An individual assignment is preferably relatively straightforward, and merely requires that the student post a message including work, either directly or in the form of an attachment or link, and grading is preferably determined according to objective and/or subjective criteria by the instructor, for example, as shown from the student perspective in FIG. 53.

A peer assignment preferably requires each student post a draft of a work product for peer review, review at least one draft product of another student, and answer questions relating to assessment criteria (such as the criteria to be used in grading). The student then preferably receives the answers to the questions and may use them for revision of the work product. If graded, the system preferably automatically grades at least a portion of the peer assignment based on objective criteria, such as whether the student posted a draft before a deadline and/or whether the student posted answers to the assessment questions before a deadline. The instructor may preferably grade the final work product according to the assessment criteria, and the system may automatically generate an overall grade for the peer assignment.

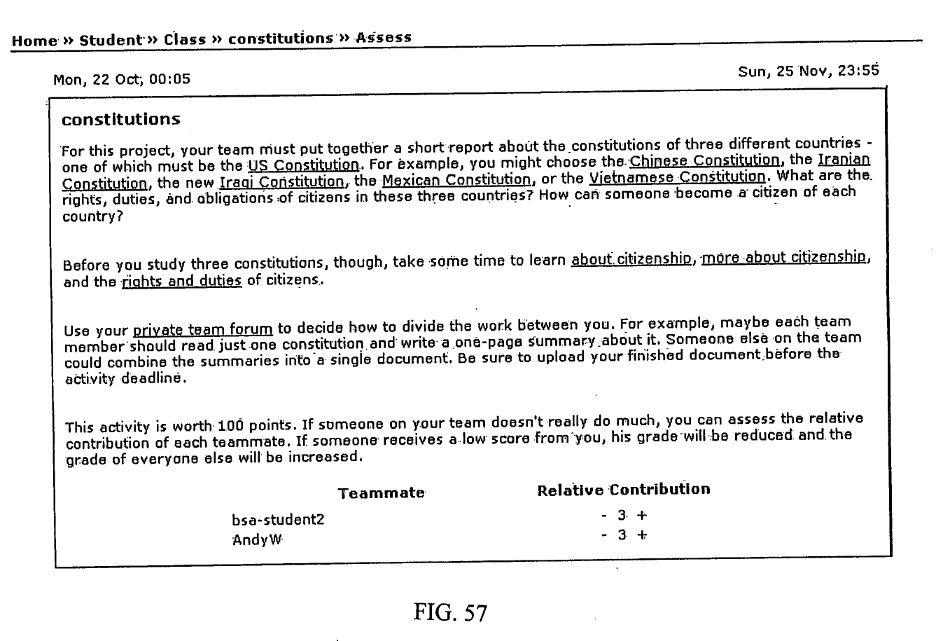

A team assignment preferably allows one or more team member(s) to post work product on behalf of the team. If graded, the team work product is preferably assessed by the instructor, and the assessed grade is preferably used for each team member's grade. Additionally, however, another component of each team member's grade is based on contribution assessment provided by each team member for each other team member, such as by use of the interface shown in FIG. 57. For example, each team member may preferably rate the contribution of each other team member, such as on a scale of 1-5. The system may preferably automatically adjust an individual team member's grade up or down from the team grade based on an absolute or relative score average provided by the other team members.

Quizzes and assessments allow the instructor to gauge the progress or knowledge of the student(s), and may include parameters such as whether a time limit is included, whether a deadline is involved, whether returning to a previous questions or portion is allowed, whether use of external resources is permitted, whether the activity is graded, whether practice is allowed, whether results are displayed, and the like.

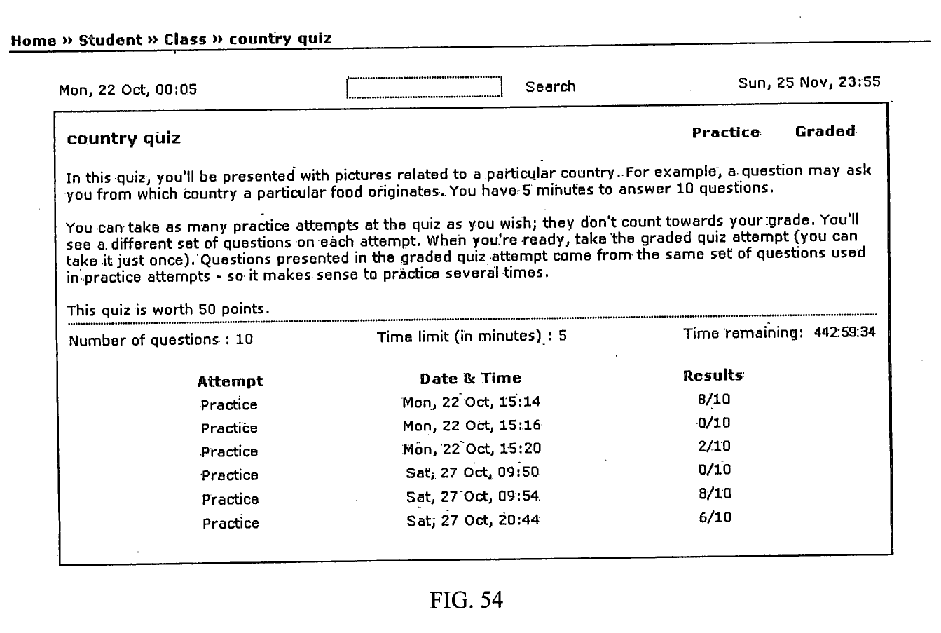

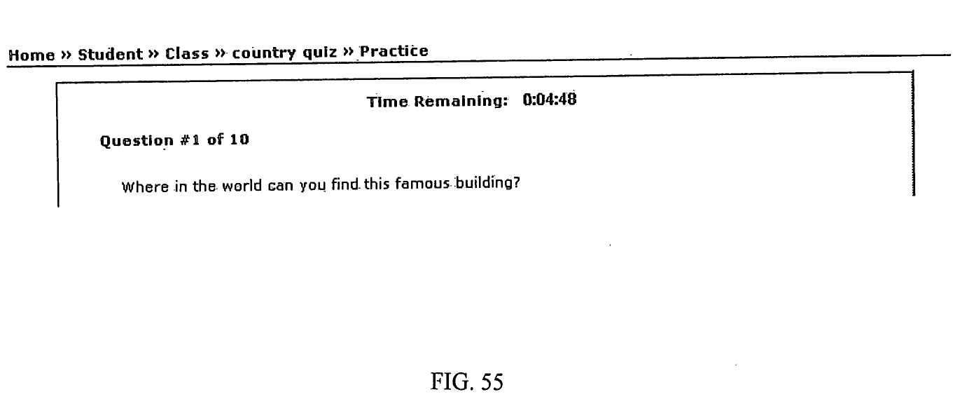

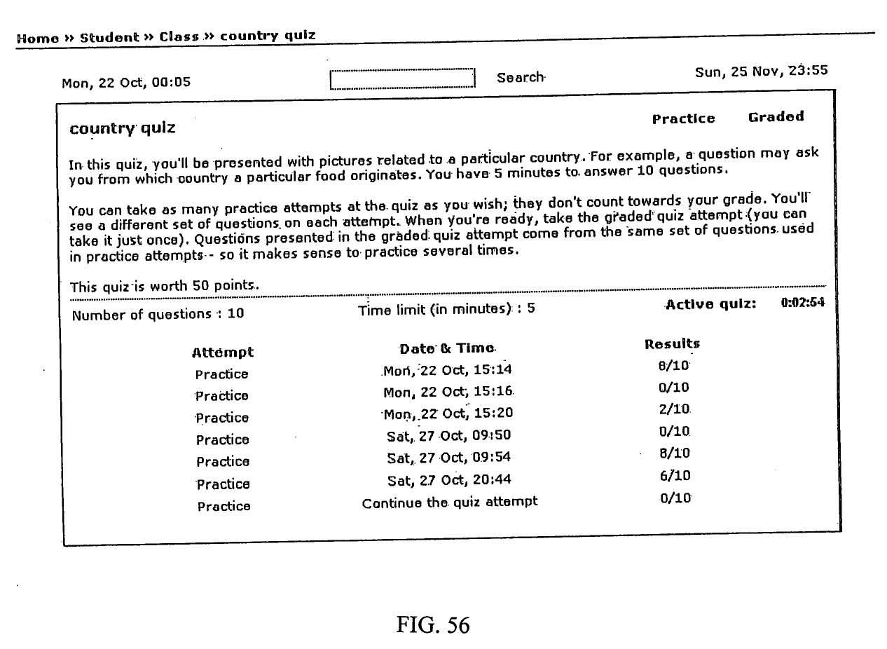

A quiz is preferably an objectively graded activity, whereas an assessment preferably includes one or more subjectively graded portion, such as an essay graded by an instructor. In an exemplary embodiment, a quiz preferably includes only multiple choice questions. The quiz preferably allows for practice and has an adjustable default parameter for a number of questions in a graded quiz, a number of questions in a practice quiz, a time limit, a number of practice attempts allowed, or the like. A student view of a quiz screen is shown in FIGS. 54 and 56, and preferably includes buttons and/or links, or the like, to select practice or graded quiz attempts, or the like. Each question preferably has a plurality of answer choices, an indication as to whether each answer choice is correct or incorrect (more than one answer choice may be correct for each question), an explanation as to why the answer choice is correct, or not, a toggle for designation as a practice question, a toggle for designation as a graded question (both may be selected), and whether multiple answers may be selected. Preferably, if multiple answers may be selected, all correct answers must be selected for the answer to be marked as correct. To distinguish, radio buttons are preferably used if only one answer choice may be selected, whereas check boxes are preferably used if multiple answer choices may be selected. An exemplary embodiment of a student view of a quiz question (part of a quiz attempt) is shown in FIG. 55.

The designation of a question as a practice question allows it to appear in a practice quiz, and, likewise, the designation of a question as a graded question allows it to appear in a graded quiz. The questions of a practice quiz and/or a graded quiz are preferably selected randomly from all questions having the corresponding designation. Thus, limits may be used to avoid a student reviewing all the questions during practice quizzes. Alternatively, each question may be designated as only one of a practice question and graded question.

Materials may be associated with the course, and, more specifically, with one or more lesson(s) and/or activity(ies). For example, general reference materials may be associated with an instructor forum that persists throughout the entire course, and may be accessed by all students. Other material, such as an assigned reading, may be associated with an assignment activity, and access may be limited to a particular student, or group, and may be limited to a predetermined time. Other material(s) may similarly be associated with other activities, as desired. Materials may take the form of files, such as text, image, sound, or video files, available for download by students, or may take the form of a link to another source, such as a webpage. Preferably, files may be embedded in an activity in the form of a link to the file, such as a text, audio, visual, or multimedia file. Activation of the link causes the file to be downloaded and displayed. Website links may likewise be embedded in an activity, however, no file associated with the link needs to be uploaded to the system, and activation of the link preferably causes the user to view the designated webpage. Additionally, a graphic may preferably be embedded directly into an activity, such as an image that will appear in the activity at the location of the graphic. Audio and video graphics may preferably, likewise, be included.

When designer 102 has completed adding, modifying, and/or deleting lessons and activities, designer 102 may save the course to course database 121. Preferably, prior to the course being saved, host 111 validates the course by comparing the selected lessons and activities with predetermined-criteria. For example, if the grade attribute is assigned, host 111 may verify that a predetermined number of graded activities are included, or that each quiz includes at least a minimum number of questions. Accordingly, system 100 ensures that each course saved in course database 121 conforms not only to permissions associated the attributes assigned to the course, but also with any other predetermined criteria desired.

As will be understood by those ordinarily skilled in the art, each user, such as designer 102, may be associated with only selected courses (or classes, depending on the role), such as those created by that particular designer and/or those courses associated with one or more organization, unit, level, and/or package, or the like, with which the user is affiliated in the designer role. Thus, the user may only be able to access, modify, and delete those courses with which they are associated, either individually, or by organization, unit, level, package, or the like. Furthermore, the template, i.e. the available attributes and/or the permissions associated therewith, the layout, and/or the predetermined validation criteria, may be different for different designers, organizations, units, levels, packages, or the like. Preferably, however, the template is uniform throughout system 100. Thus, different organizations, such as business or schools, may have a unique layout, validation critera, or the like, associated therewith, as desired. Such unique characteristic may be aesthetic, such as a background in a school's colors, or may be substantive, such as when the validation criteria or attribute set is unique. When more than one such unique template is available to a given designer, the designer may preferably select which template applies to a given course.

As will be understood by those ordinarily skilled in the art, each different template for course creation introduces complexity, and, therefore, cost, potential errors, potential confusion, and the like. Thus, in a preferred embodiment, only one template is available on the system, whereby every course will be designed according to the preferred criteria, and whereby every class available on the system embodying a course is likewise consistent with respect to design. Such uniformity preferably fosters a community of users, including designers, managers, instructors, and students who may create and participate in courses and classes with relatively few barriers.

Similarly, if more than one template is allowed on the system, the system may segregate users according to templates. For example, if two templates are available for designers, students may only be able to access classes created from courses designed with one or the other template, but not both. Thus, at least to the segregated user(s), the system may maintain the preferred uniformity in features, appearance, or the like.

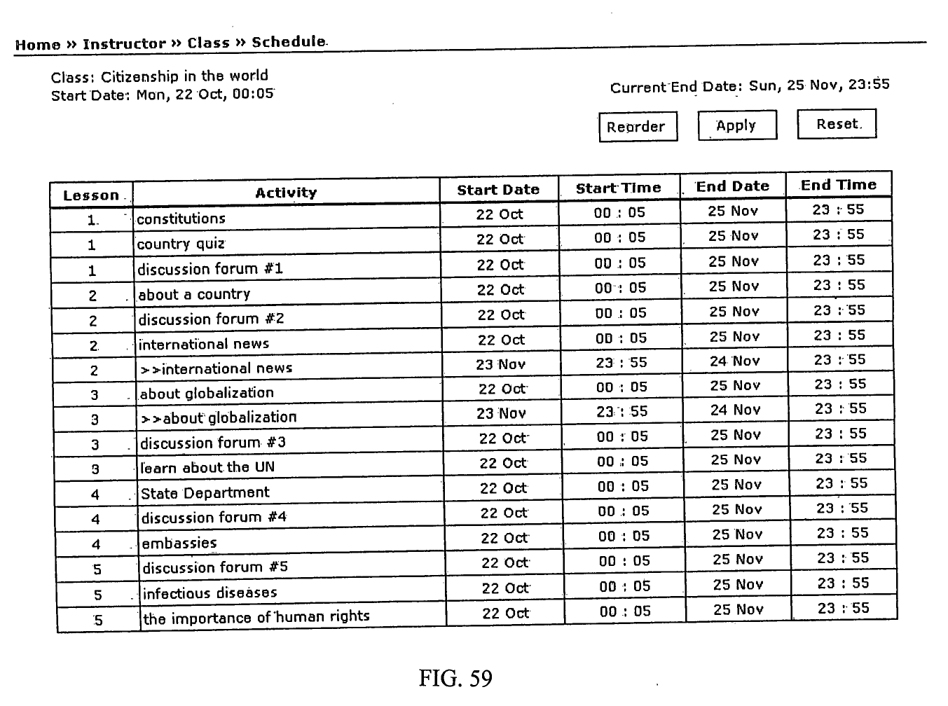

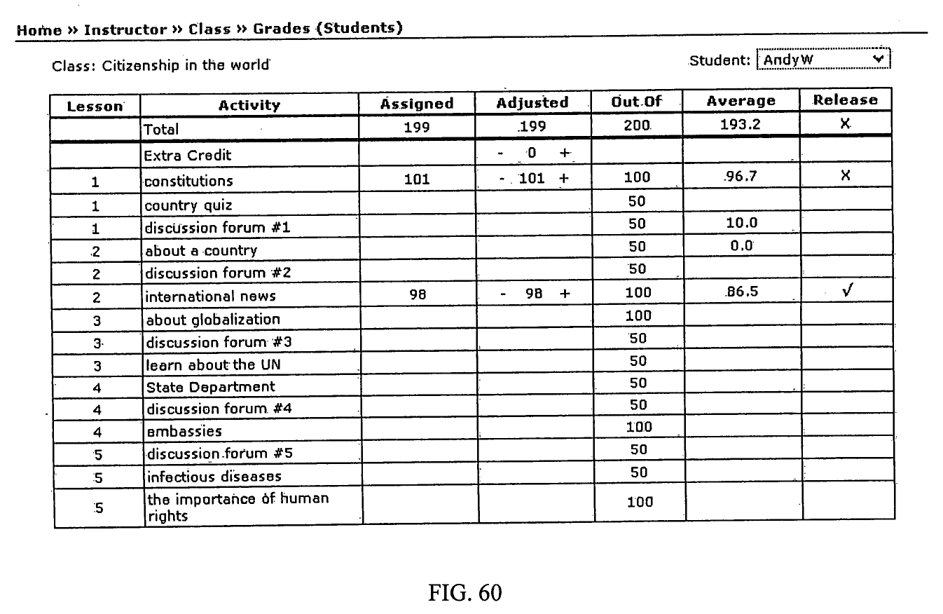

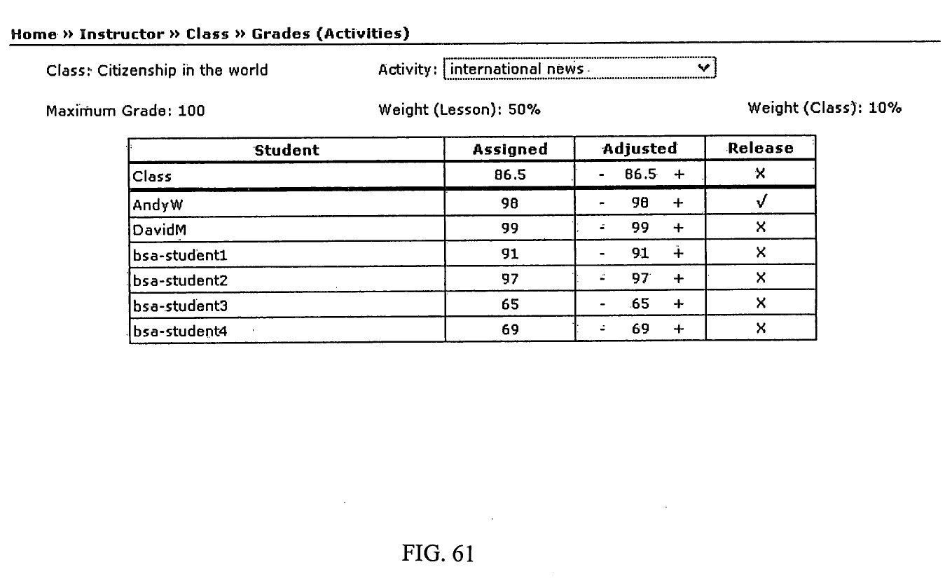

Once a course has been saved to course database 121, system 100 preferably makes it available to manager 104 for use in creating one or more class(es), although availability may be limited depending on information associated with manager 104. For example, manager 104 may only be able to access courses which manager 104 has previously purchased, which are associated with a particular organization, unit, level, package, or the like, with which manager 104 is associated, or which have been assigned to manager 104, as desired. Manager 104 may have permission to add students and scheduling information, e.g. class beginning and ending dates, and beginning and ending dates for each lesson and/or activity, to a selected course to create an instance of the course that will be offered as a class. Optionally, as illustrated in FIG. 59, an instructor may additionally have access to scheduling functions of system 101, such as to account for unanticipated delays, or the like, including those caused by payment ability or issues. Preferably, manager 104 need only indicate a starting date and a term length and system 100 preferably automatically populates all the other beginning, ending, and due dates, or the like. Additionally, manager 104 may add other information specific to the class, such as adding activities, materials, message board postings, instructions, or the like, and/or may modify existing information, such as quiz questions, grading weights, or even attributes of activities, as desired. Different permissions may be granted to different users based on user information, such as an affiliation with a given organization, unit, level, package, or the like, and/or may be assigned differently for each course and/or class. Preferably, however, manager 104 may not alter lessons or activities, and may instead only select a course from a list of available courses, select a start date, select a class duration, select a number of students, select a number of instructors, specify the instructor(s), adjust the weight given to the graded activities included in the course, and optionally specify some of all of the students. Such preferred limited control is selected to address the needs of a school administrator, wherein decisions relating to enrollment, instructor assignment, and costs (based on the preferred billing method discussed below). Accordingly, and as shown in FIGS. 60 and 61, an instructor may have permission to adjust the grades of students in the class, or associated with a selected activity, but may not adjust the grade attribute.

When manager 104 has created the class, the version of the course comprising the class is preferably saved to class database 123. Host 111 may verify that manager 104 has the necessary permission, such as based on affiliation with an organization, unit, level, package, or the like, and/or based on payment information from payment database 131. Class database 123 may include an archiving feature such that the unique materials and the contents of the activities may be saved for future retrieval, if desired. The archiving feature may be performed on a remote server or other remote storage device, or may be embodied as a download feature whereby a student, instructor, manager, or even a designer, may save a copy of the class locally.

System 100 preferably accommodates interaction via various devices, and in a variety of formats. For example, student 108 may preferably access system 100 via telephone, and may, accordingly, supply or receive information in an audio format. Host 111 is preferably capable of converting information from a first format to a second format to facilitate such flexibility. Thus, host 111, or another appropriate component of system 100, is preferably capable of conversion between speech and text, as well as between languages, or the like. For example student 108 may access a forum message via telephone, wherein student 108 may navigate via push-button response to a computer-generated or recorded voice menu, and upon selection, may listen to a computer-generated or recorded presentation of the message contents. Student 108 may further record a response for display in audio and/or text form for subsequent viewers of, or listeners to, the response.

Access to system 100 may be selectively granted according to payment information, such as that stored in payment database 131, associated with a particular user and/or an organization with which the user is associated. For example, designer 102 may create a course and save the course to course database 121. A fee may or may not be associated with such creation and storage, according to the desire of an individual or organization operating system 100. Manager 104 may access and/or use the stored course for a fee, which fee may be paid to designer 102 or may be split between designer 102 and the individual or organization operating system 100.

In one embodiment, an electronic token (e-token) system is included wherein individuals and/or organizations may purchase e-tokens, such as from an operator of system 100 or another vendor. The system may automatically collect tokens, either instantaneously or periodically, based on selected activity, such as scheduling a class, enrolling in a class, saving a course, saving a class, or any other activity of a user. Furthermore, in a preferred embodiment, the payment system takes the form of a pay-as-you-go implementation, wherein the system may collect tokens on a flat-rate basis, based on the number of students enrolled in all classes offered by a particular manager 104. In the preferred embodiment, the system captures enrollment data automatically according to a set schedule, such as daily, and multiplies the number of enrolled students by the flat rate, such as ten cents per student, per day.

Additionally, or alternatively, system 100 may be designed to collect e-tokens from each user, or only from selected users or types of users. For example, system 100 may collect tokens only from managers based on enrollment in classes, as discussed above. In such a case, system 100 or other users may transfer e-tokens directly to another user based on another selected action by a user. Continuing with the example, e-tokens may be transferred to the manager upon enrollment on a student in a class, which tokens may be used by the manager to pay the automatically-assessed system fees. Another payment option involves “seat” licenses, which may be transferable, wherein the “seat” licenses may be purchased by a manager, or an organization with which the manager is associated, and may be used by the system to deduct an equivalent number of enrolled students from the calculation of fees of the preferred embodiment. Such “seat” licenses may be purchased with e-tokens, or may replace or supplement the e-token system. Thus, fee collection via credit card, debit card, PAYPAL account, payroll deduction, bank transfer, or the like, may be implemented. Thus, system 100 preferably includes a system for fee splitting between designers, managers, and/or an operator of system 100.

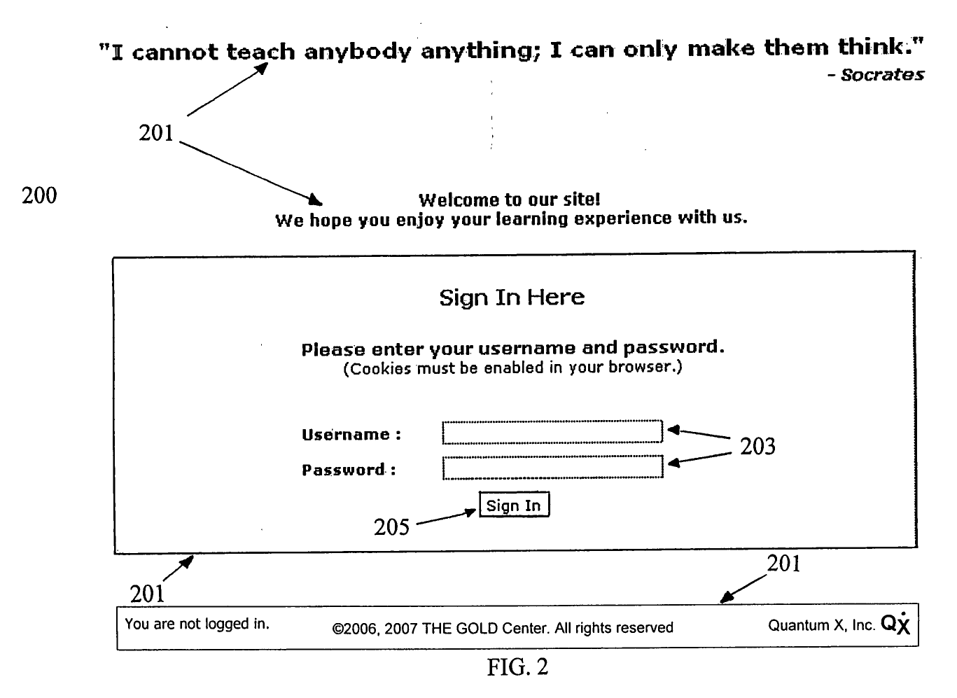

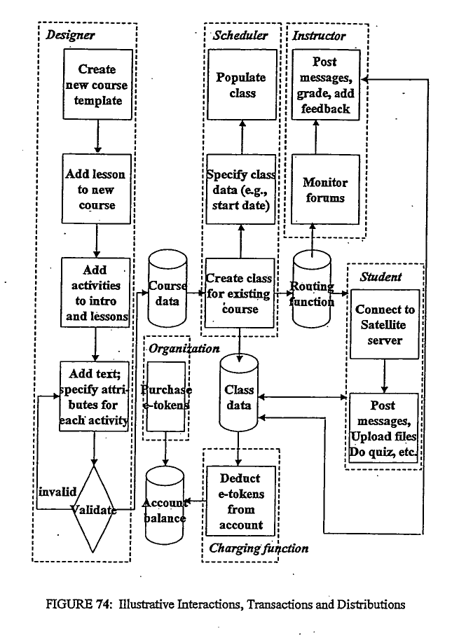

Referring now to FIGS. 2-74, a user, such as designer 102, manager 104, instructor 106, or student 108, preferably accesses host 111, such as via designer terminal 101, manager terminal 103, or student terminal 105 and network 141. The step of accessing host 111 is preferably carried out via accessing a page of a website using an Internet browser program, but may, alternatively, be carried out via a dedicated client program or other computer program, including those executed on mobile devices, or the like. In response, host 111 preferably provides information causing screen 200 to be displayed to the user.

Screen 200 may include one or more banner(s), bar(s), frame(s), panel(s), window(s), or the like 201, each of which may include text and/or graphic components, as desired. Screen 200 preferably further includes data-entry areas 203 wherein the user may enter identification information, such as a username and password. When user activates button 205; the identification information entered in data-entry areas 203 is preferably transmitted to host 111 via network 141 for verification. Host 111 preferably compares the entered user identification information with a database of user identification information, such as payment database 131, and determines whether the entered user identification information matches stored user identification information associated with a user. If the entered user identification information does not match the saved user identification information for any user, then host 111 causes screen 300 to be displayed to the user, indicating that the login attempt failed, and allowing the user to re-attempt to log in. Screen 300 may, likewise, include one or more banner(s), bar(s), frames(s), panels(s), window(s), or the like 301, and preferably includes data-entry areas 303 and button 305 for entry and submission of user identification information.

If, however, the entered user identification information does match the saved user identification information for a user, then host 111 may cause screen 400 to be displayed to the user. Screen 400 includes user information 401 and at least one link 403. User information 401 may include the user's username, previous login information, organizations with which the user is associated, and/or roles available to the user.

Activating any of links 405 preferably causes an associated page to be displayed. For example, if the user activates a “profile” link 407, then “profile” page 700 is preferably displayed, wherein the user may add, modify, and/or delete user information and/or preferences, or the like, via data-entry areas 703 and/or buttons 705. The user may return to screen 400 when finished.

After reviewing user information 401, and optionally verifying accuracy of same, the user may activate link a link 403 associated with an organization and/or role that the user desires to access. Thus, the user may preferably be required to select an organization/role combination (as a user may have different roles for the same organization, and/or the same role for different organizations) before proceeding to the homepage via activation of the associated link 403. The selected organization and role may then be set for billing and/or permissions purposes, or the like, and preferably control which screen(s) may be displayed to the user, and the content of those screens, based on associated entries in course database 121, class database 123, and/or payment database 131. In an alternative embodiment, the user may not have to make such an organization/role selection at this point, but may have to make such a selection at some later point.

Host 111 may, optionally, determine whether the user has previously agreed to the terms of use of system 100 and/or a selected affiliated organization. If the user has not previously accepted such terms of use, host 111 may cause screen 500 to be displayed, including terms of use 501, “accept” button 503, and “reject” button 505. If the user activates “reject” button 505, then the user is preferably logged out of system 100 and is not permitted to access any functions thereof before logging in, and accepting the terms of use, if necessary. For convenience, screen 200 may be displayed to the user if “reject” button 505 is activated. If the user activates “accept” button 503, then host 111 may cause screen 600 to be displayed to the user. In an exemplary embodiment, “accept” button 503 may not be activated until a user views the entire terms of use 501, and preferably the terms of use 501 displayed relate to the previously-set affiliated organization, with the terms of user of system 100 having been previously viewed and accepted, such as during an account creation process.

Screen 600 is an exemplary “home page” of system 100, for a user-selected organization/role combination, and may include one or more banner(s), bar(s), frame(s), panel(s), window(s), or the like 601, links 603, user-available content area 605, and one or more button(s) 607. In one embodiment, one or more user-targeted add is included in one or more banner(s), bar(s), frame(s), panel(s), window(s), or the like 601, preferably based on user information, such as that stored on payment database 131, and/or may be based on a saved user account history, or the like, such as may be saved for predicting and suggesting classes of interest to the user, or the like. As will be understood by those ordinarily skilled in the art, one or more banner(s), bar(s), frame(s), panel(s), window(s), or the like 601 of screen 600 may be duplicated on other screens, or analogous elements may be provided on other screens, as desired.

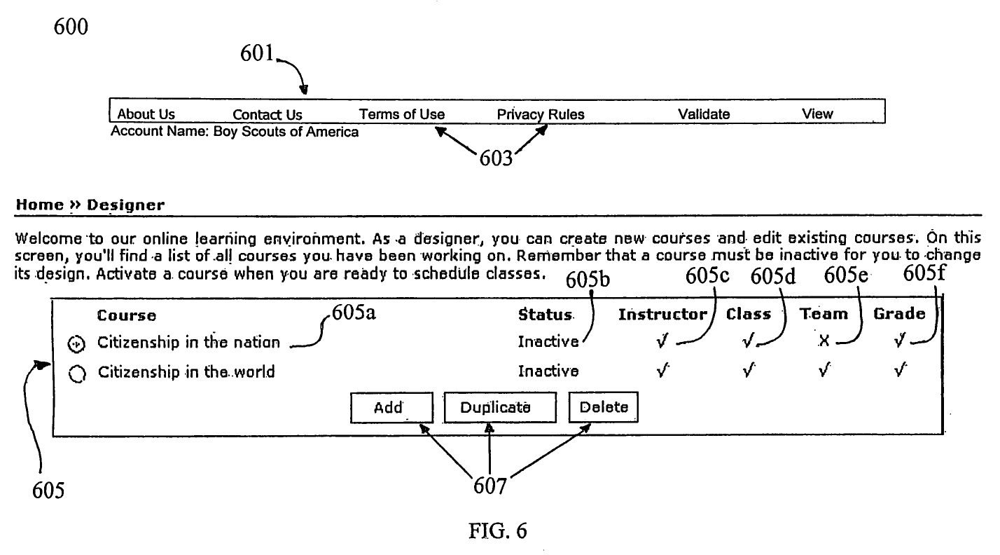

Depending on the organization/role combination previously set (such as at screen 400), one or more course(s) and/or class(es) may be displayed in user-available content area 605 of screen 600. As shown in FIG. 6, only courses are available in the exemplary version of screen 600, corresponding to a designer role that, according to the preferred embodiment, does not permit access to classes. Alternatively, the absence of classes may be the result of there simply being no classes associated with the selected organization/role combination.

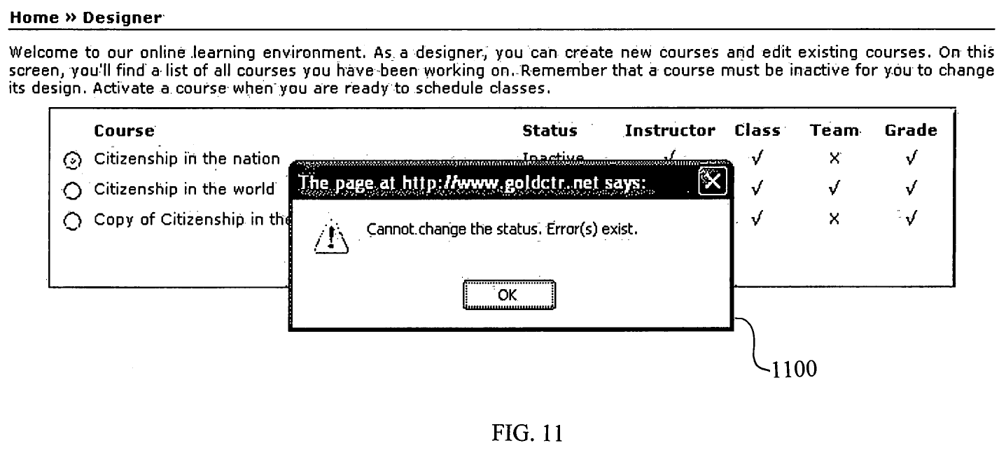

In order to add a new course, duplicate a course, or delete a course, the user may select a desired course, such as via highlighting, a radio button, or the like, and activate one of buttons 607 corresponding to a desired function, i.e. an “add” button, a “copy” button, or a “delete” button, or the like. Alternatively, the user may access a desired function via activating a portion of user-available content area 605a-f, such as a hypertext link, or the like. In the illustrated preferred embodiment, activation of user-available content area 605a may enable the user to modify an existing course. Preferably, only inactive courses may be modified. Similarly, activation of user-available content area 605b may preferably toggle a status of the course between an active status and an inactive status. The status of the course defines whether a course is available to one or more other users, such as those in a manager role, for use in creating a course. Accordingly, system 100 may preferably not allow a designer to change the status of a course from inactive to active unless the course is validated by a validation function of system 100, wherein the course is checked for errors or other irregularities. For example, and as shown in FIG. 11, system 100 preferably automatically validates the selected course when the status is changed to active. If the selected course fails the validation process, such as due to one or more errors, system 100 preferably presents notice pane 1100. Activation of any of user-available content areas 605c-f may, optionally, toggle a respective one of an instructor attribute, a class attribute, a team attribute, and a grade attribute, however, preferably such a change in attribute is not permitted a screen 600.

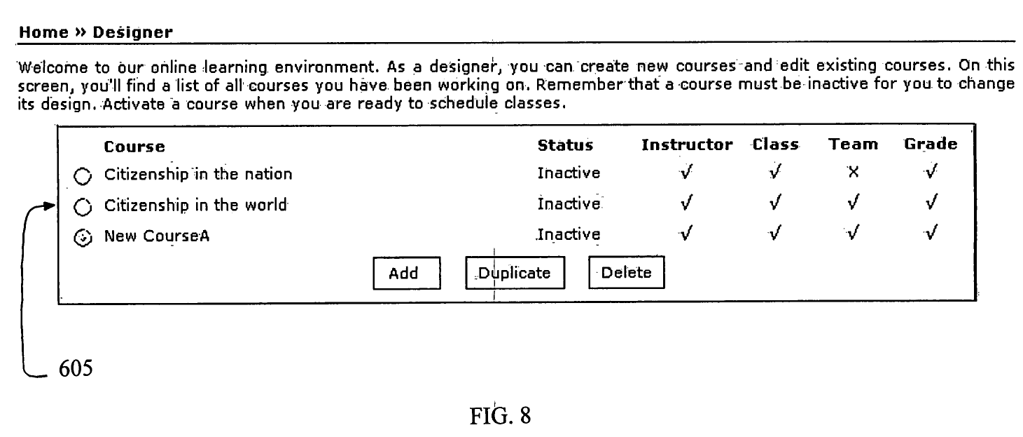

Specifically, activation of an “add” feature, such as via activation of a corresponding button 607, preferably causes a new course to be displayed in user-available content area 605, as shown in FIG. 8. The new course is preferably created according to default criteria, which may be system-defined, organization-defined, and/or user-defined. Thus, the new course is preferably created with an appropriate title, such as “New Course $”, where “$” represents at least one character selected by the system to provide the new course with a unique name among the courses listed in user-available content area 605, among all courses on the system, or the like.

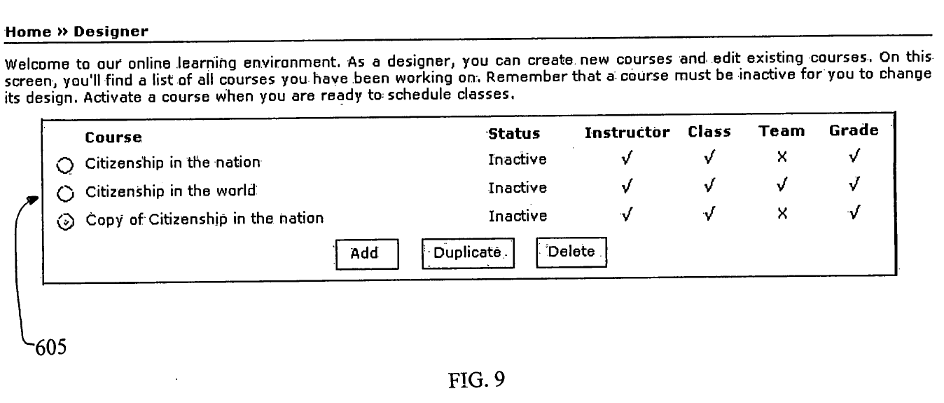

Likewise, activation of a “copy” feature, such as via activation of a corresponding button 607, preferably causes a duplicate course to be displayed in user-available content area 605, as shown in FIG. 9. The duplicate course is preferably created according to the criteria of the selected course. The duplicate course is preferably created with an appropriate title, such as “Copy $ of #”, where “#” is the name of the selected course, and where “$” represents at least one character selected by the system to provide the duplicate course with a unique name among the courses listed in user-available content area 605, among all courses on the system, or the like.

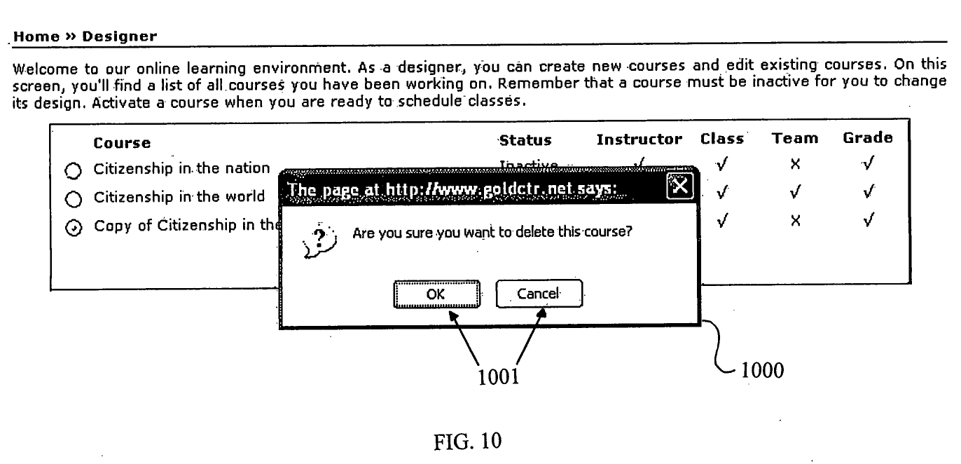

Activation of a “delete” feature, such as via activation of a corresponding button 605 may preferably remove the selected course from user-available content area 605. System 100 preferably warns a user regarding such removal of a course, in order to reduce accidental or unwanted removal of a course, via presentation of confirmation pane 1000, as shown in FIG. 10. Confirmation pane 1000 preferably includes one or more button 1001, or other input means, whereby the user may confirm the desire to remove the selected course, or may cancel the removal, as desired.

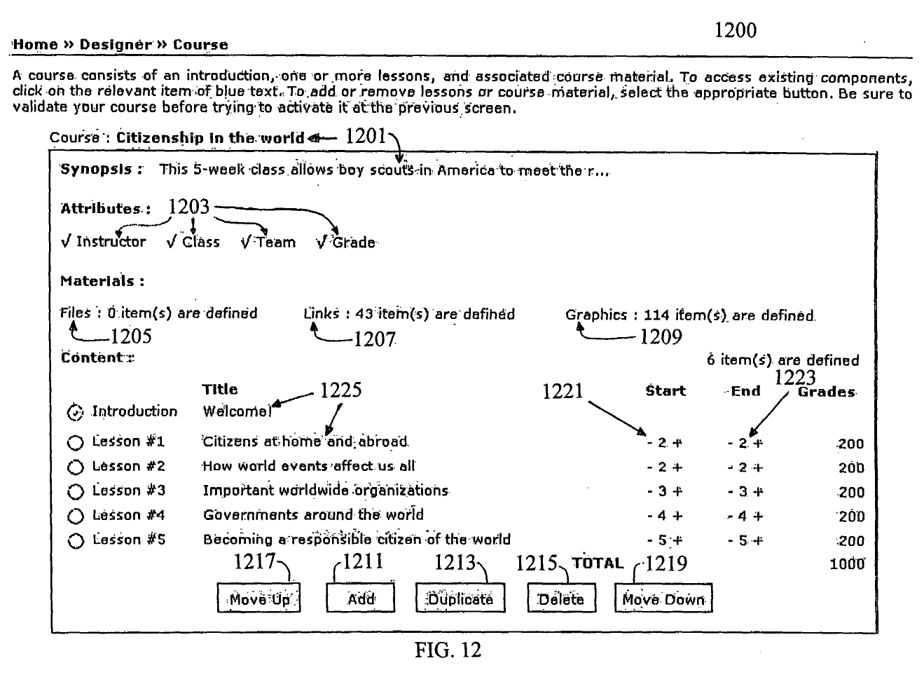

Activation of user-available content area 605a preferably causes system 100 to display screen 1200, as shown in FIG. 12, wherein the course may preferably be modified. Link(s) 1201 may preferably be activated to access one or more screen of system 100 wherein a course title and/or a synopsis of the course may be modified. The course title and/or synopsis may be used by system 100, such as in facilitating one or more student(s) 108 in finding a desired course. In addition to, or in lieu of, user-available content areas 605c-f, links 1203 may be activated to toggle an associated corresponding attribute. Activation of one of links 1203 causing the associated attribute to be de-selected, or “turned off”, preferably causes system to present warning pane 1300 warning the user that one or more activity(ies) may be deleted. The user may confirm the action via activation of button 1301, or may cancel the action via activation of button 1303. Optionally, system 100 may perform a check process, similar to the validation process, wherein warning pane 1300 is only presented if one or more activity will, in fact, be deleted due to the action, and such activities at risk of deletion may, optionally, be listed in warning pane 1300.

It is important to note that one or more activity may be deleted via activation of link 1203 to de-select an associated attribute due to the rules of system 100. That is to say, that because system 100 allows certain activities to be included in a course only when a corresponding attribute has been assigned to the course, removing such assignment of the attribute, such as by de-selection, causes the system to forbid inclusion of certain activities. To address the conflict between the rule against inclusion of a particular activity, and the prior inclusion of the activity, the system automatically deletes the forbidden activities on de-selection of the associated attribute.

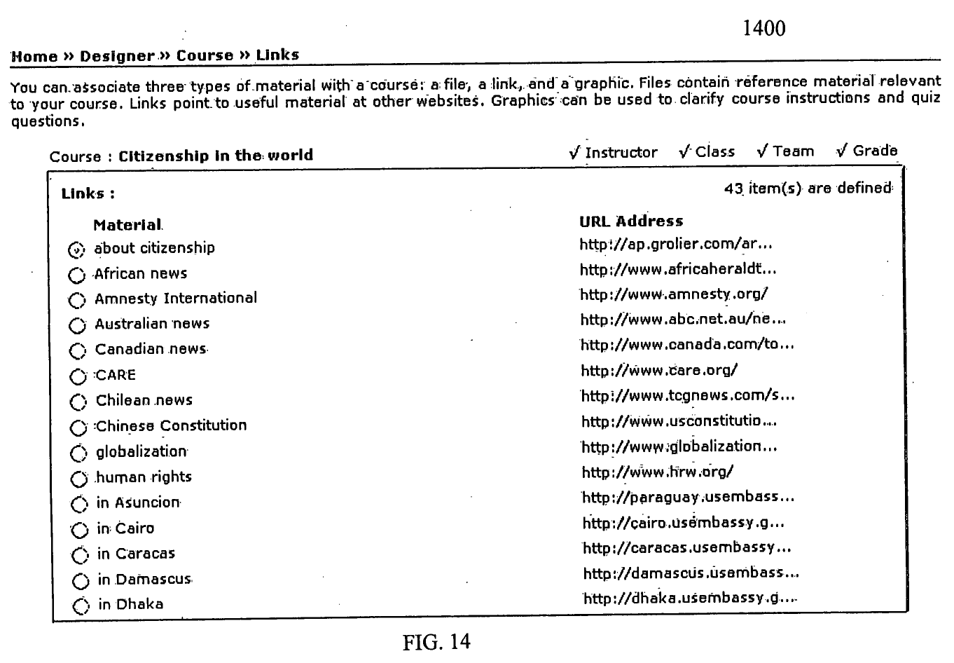

Now referring back to FIGS. 2-74, and more particularly to FIG. 12, links 1205, 1207, and 1209, may be activated to designate selected materials to be used in the course. Activation of link 1207, for example, preferably causes system 100 to display screen 1400, as shown in FIG. 14, wherein one or more link may be designated via one or more button, input field, combination thereof, or the like. As discussed above, selected materials designated through screen 1400, or an analogous screen for files and graphics, may be referred to elsewhere in the course to cause a desired element to appear based on the designated material.

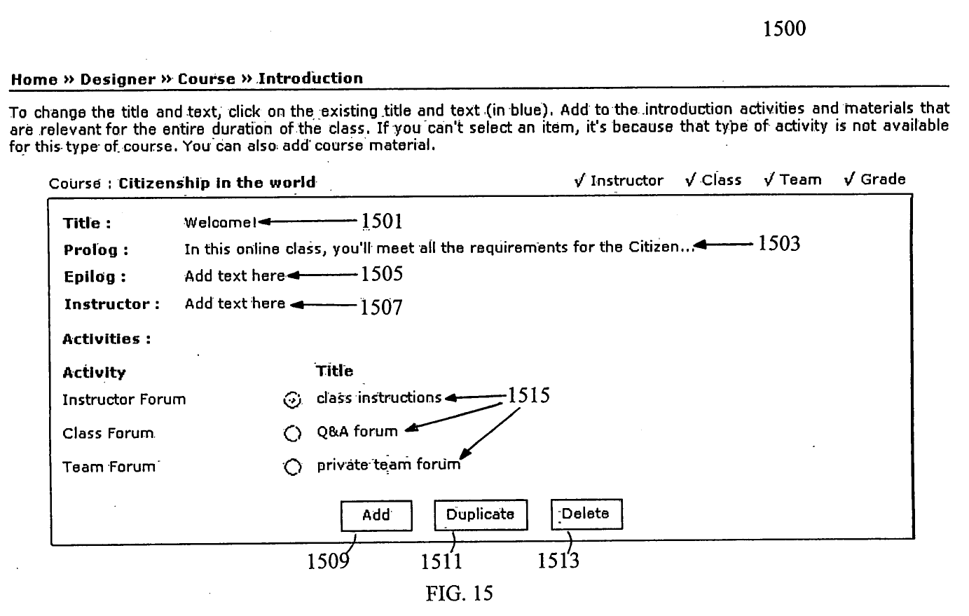

Additionally, a user may add lessons to the course via activation of button 1211, which may preferably cause a new empty or default lesson, with an appropriate unique default title, to be displayed on screen 1200 by system 100. Likewise activation of button 1213 preferably causes a duplicate lesson which is a copy of a selected lesson to be displayed on screen 1200 by system 100, with an appropriate default name, as discussed above with respect to courses. Activation of button 1215 preferably deletes a selected lesson, and all activities and other contents thereof, preferably only upon appropriate confirmation of the deletion by the user. Activation of one of buttons 1217 and 1219 preferably causes system 100 to display the selected course one space higher or lower, respectively, on the list on screen 1200. Finally, activation of link 1225 preferably allows the user to add, remove, and/or modify the contents of a selected lesson by causing system 100 to display a screen 1500, as shown in FIG. 15, corresponding to the selected lesson.

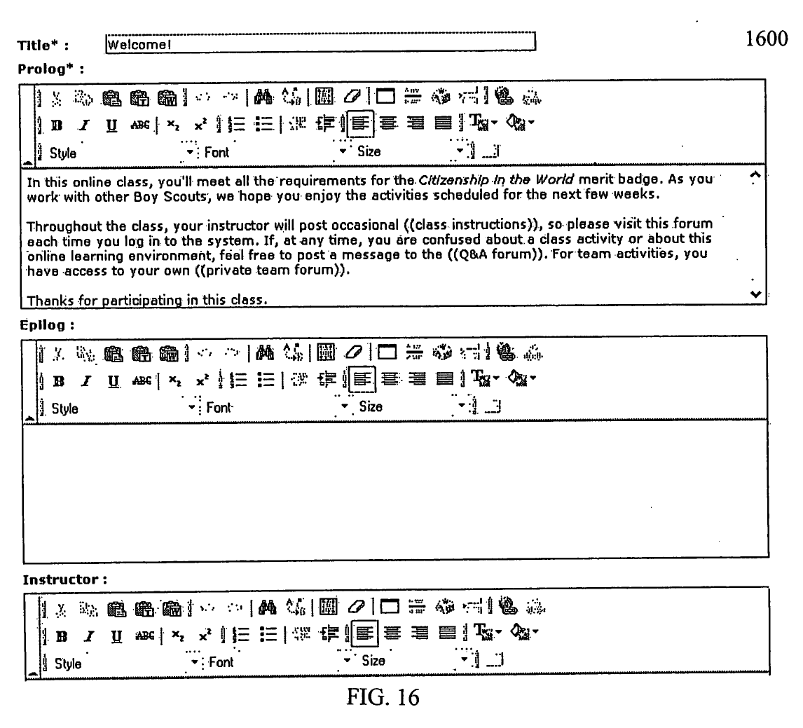

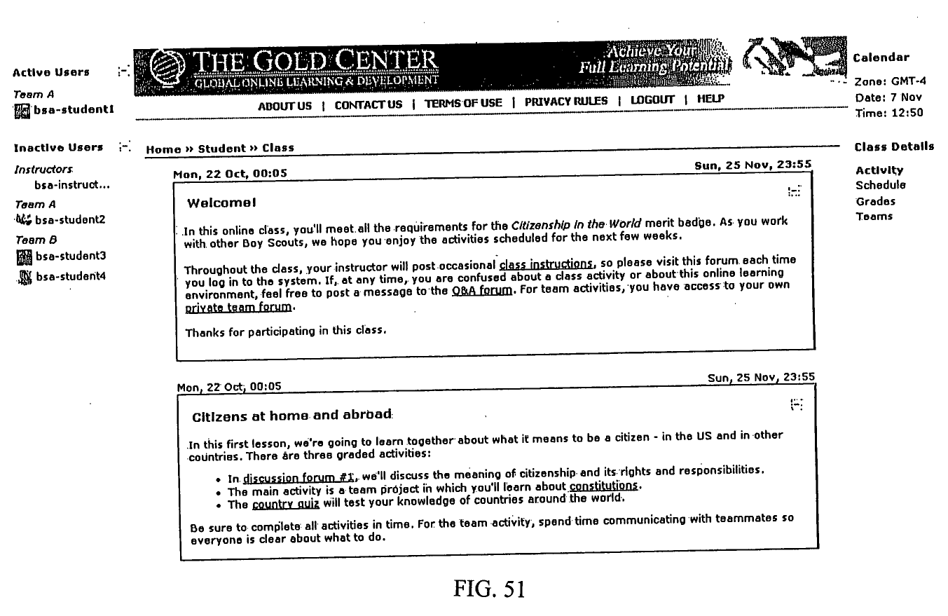

Screen 1500 may preferably be used to create a persistent lesson, such as an introduction lesson that will be accessible throughout the course (i.e. preferably modify a default persistent or introductory lesson since meaningful defaults for all activities and lessons are preferably provided by system 100 to facilitate course design). Specifically, the user may activate link 1501, 1503, 1505, and/or 1507 to access screen 1600 (FIG. 16), wherein a title, prologue, epilogue, and/or instructor note may be created and/or modified via input fields, buttons, links, or the like. The title, prologue, and/or epilogue, if included, will be visible by students accessing the lesson while participating in the class, and may include appropriate messages, instructions, suggestions, material, or the like. The prologue is preferably displayed to a student and/or instructor at the beginning of a lesson period, as shown in FIG. 51, whereas the epilogue is preferably displayed to a student and/or instructor only after the end of a lesson period. It is important to note that since a persistent lesson is being created, no epilogue is included, and system 100 may even preclude use of the epilogue for persistent lessons. Accordingly, for a limited duration lesson, discussed below, the prologue would preferably include messages, instructions, materials, and the like necessary or beneficial to participating in the lesson, or in completing activities in the lesson. Alternatively, the epilogue of a persistent lesson may be used to display information necessary or beneficial after a class has ended, such as a link to a final grade, a course evaluation, or the like. In an exemplary embodiment, the final grade may only be accessible after completion of a course evaluation. Furthermore, the course evaluation may have one or more instructor evaluation component(s), which may be used to rank or grade instructors, such as for use in aiding class selection by students.

As will be understood by those ordinarily skilled in the art, the epilogue for a limited duration lesson will preferably include material designed or selected to reinforce the teaching of the lesson, such as quiz answers/explanations, sample essays, links to additional resources, or the like. The instructor notes are preferably accessible only by the instructor(s), and are preferably available at all times, such that they may be used to direct the instructor in providing the lesson, assisting, encouraging, and/or directing students, or the like.

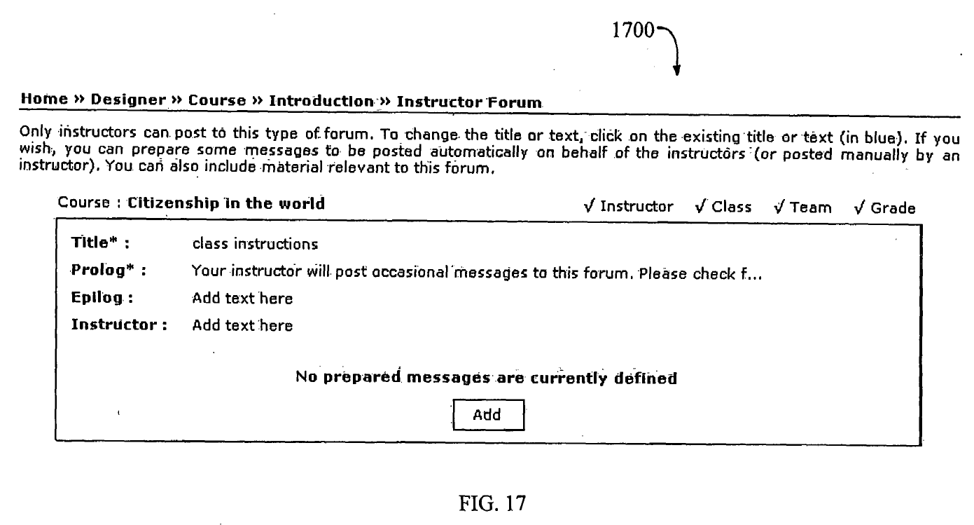

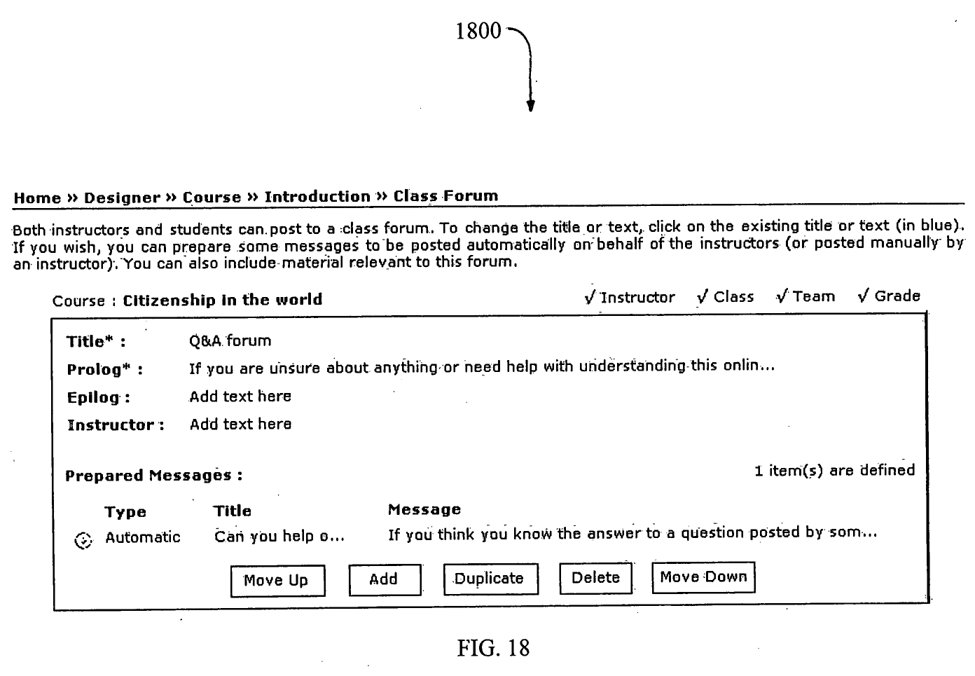

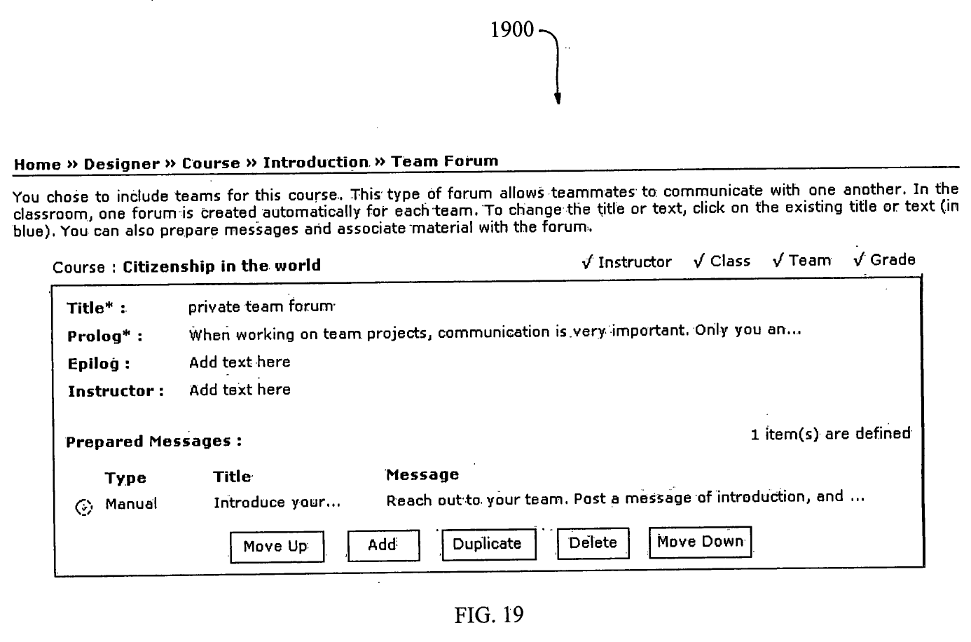

Activities may be added to the lesson via button 1509 for new activities, or via button 1511 for copies of existing activities, whereafter they may preferably appear on screen 1500 according to appropriate defaults, as discussed above with respect to adding and/or copying courses. Once created, activities may be modified using corresponding activity screens, such screen 1700 (FIG. 17) for an instructor forum, screen 1800 (FIG. 18) for a class forum, and screen 1900 (FIG. 19) for a team forum, accessed via a corresponding link 1515.

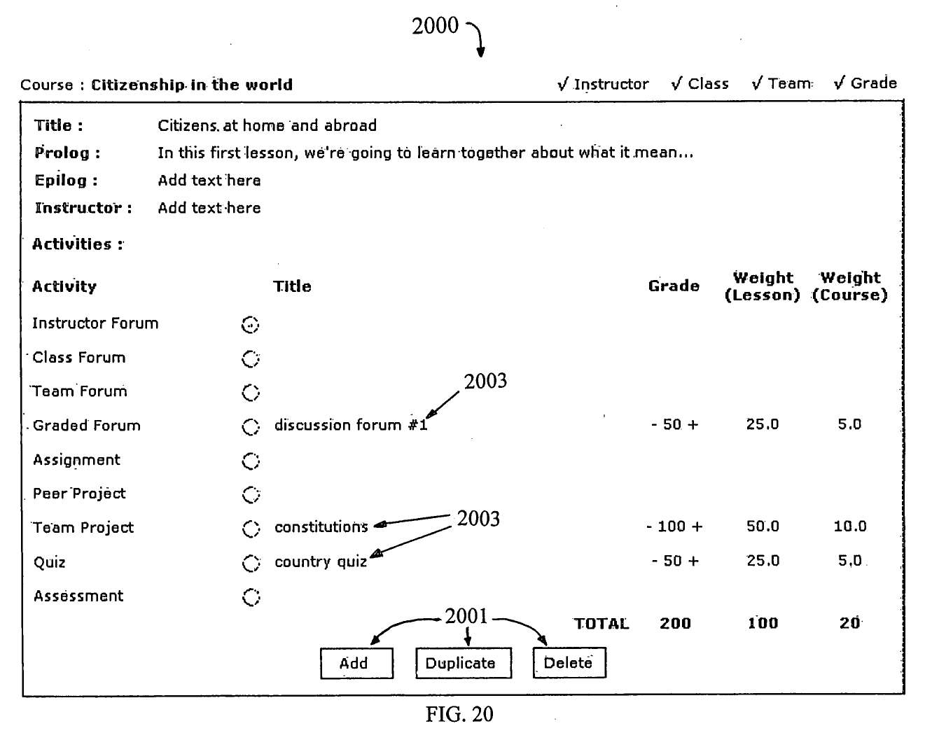

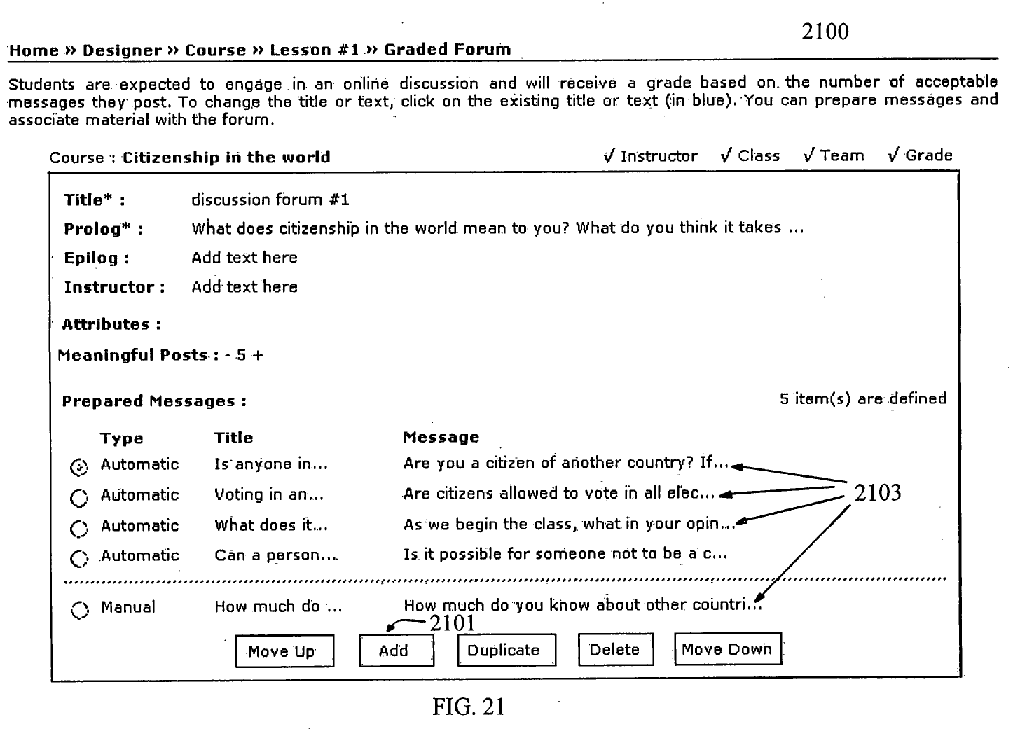

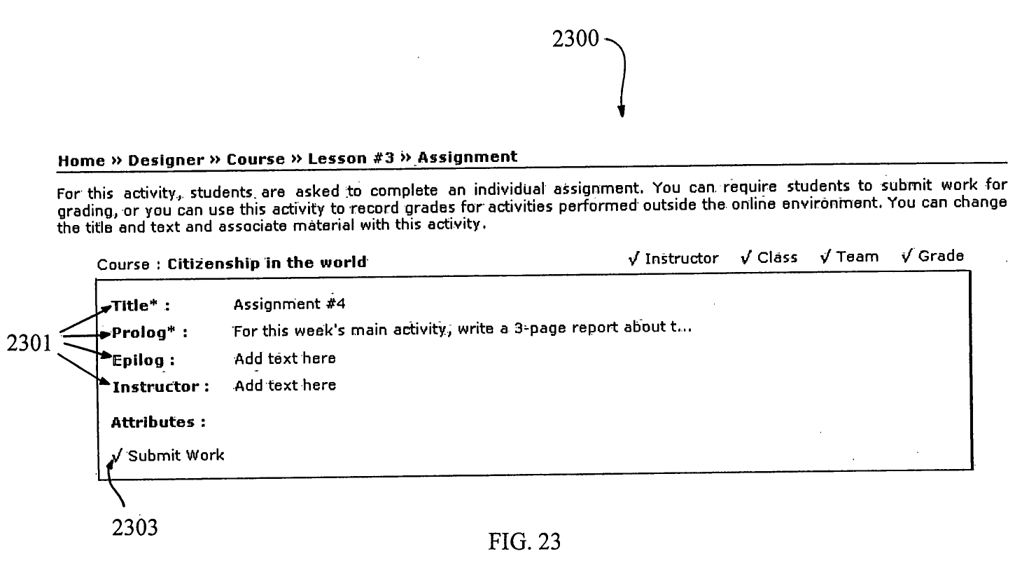

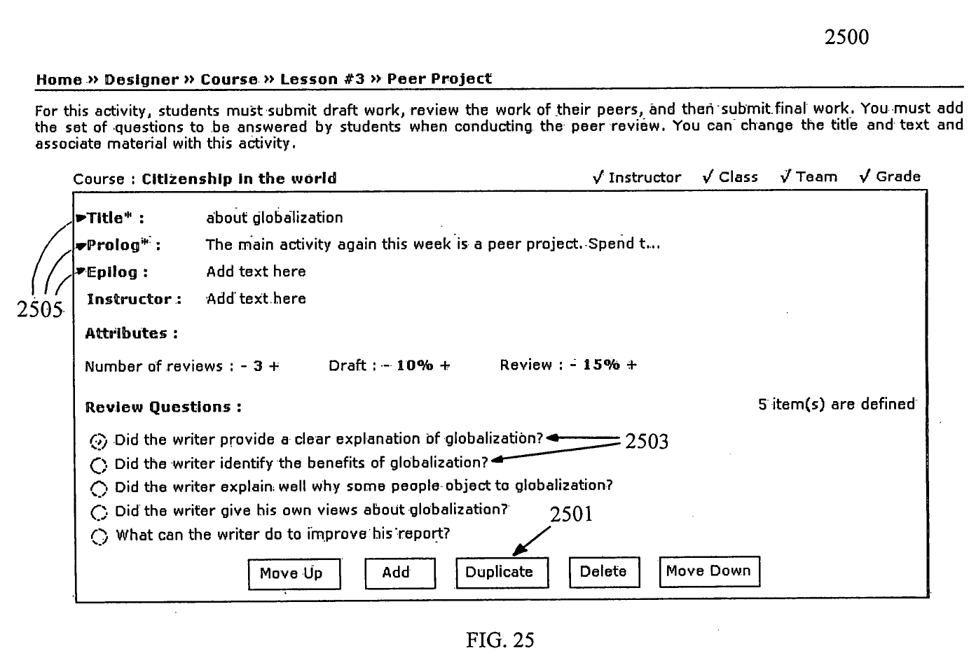

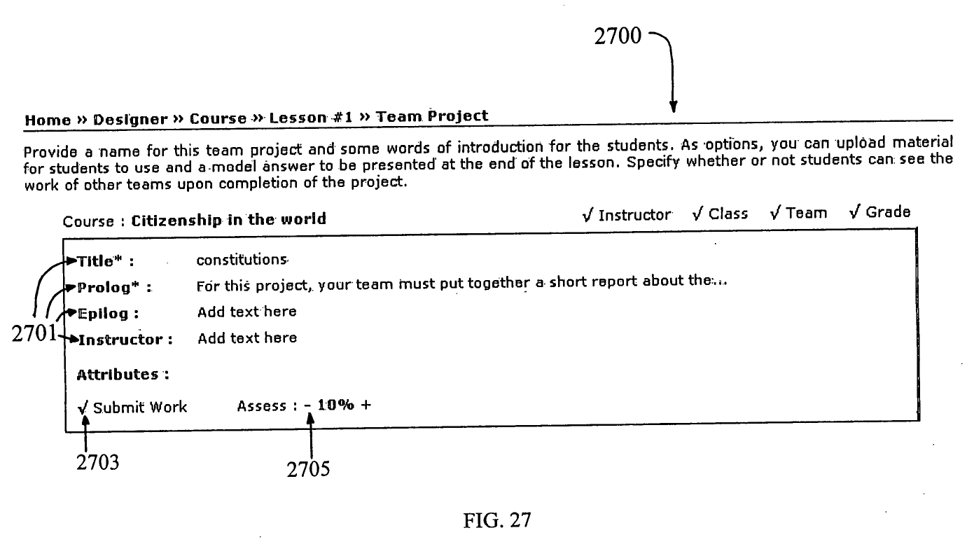

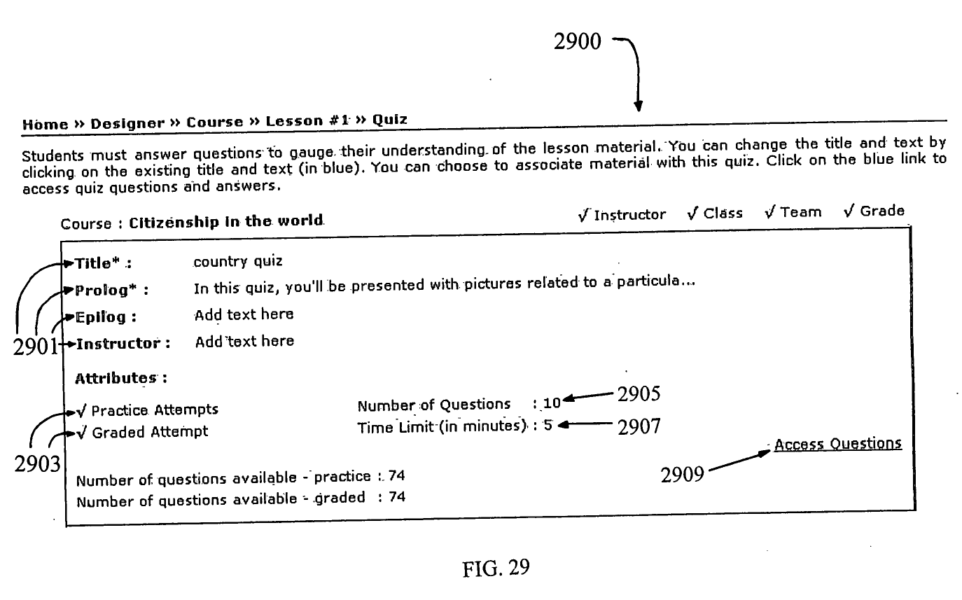

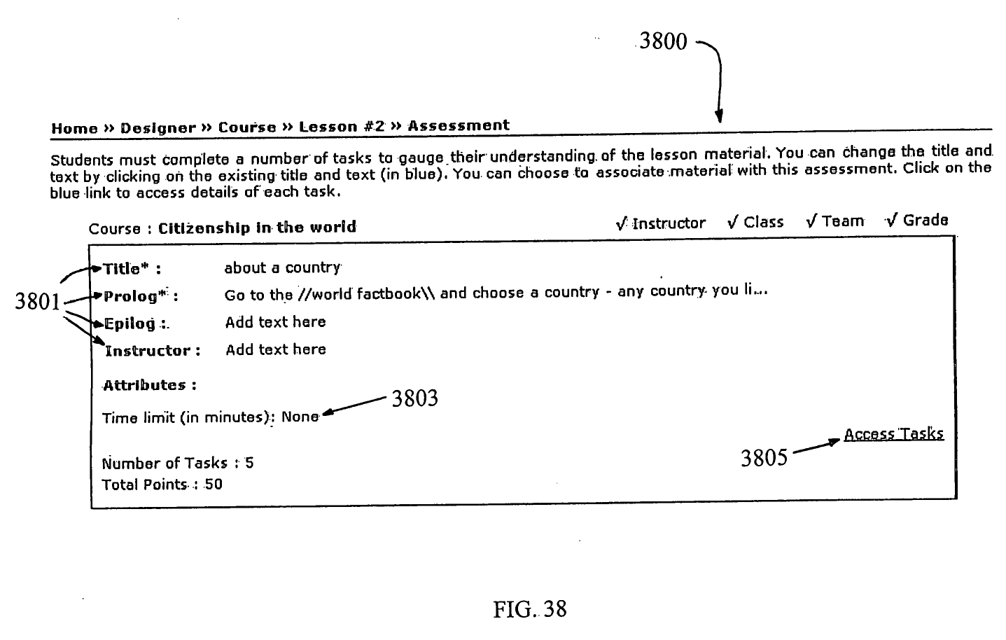

As with screen 1500 discussed above, screen 2000 (FIG. 20) may be accessed via a corresponding link 1225 of screen 1200. Screen 2000, however, is preferably used to create and/or modify a limited duration lesson. Buttons 2001 may be used to add, copy, and delete activities, which will preferably be displayed in a list on screen 2000 according to appropriate default conventions. The activities may then be modified by activating a corresponding one of links 2003, which preferably accesses screen 2100 (FIG. 21) for a graded forum, screen 2300 (FIG. 23) for a graded assignment, screen 2500 (FIG. 25) for a peer project, screen 2700 (FIG. 27) for a team project, screen 2900 (FIG. 29) for a quiz, and/or screen 3800 (FIG. 38) for an assessment.

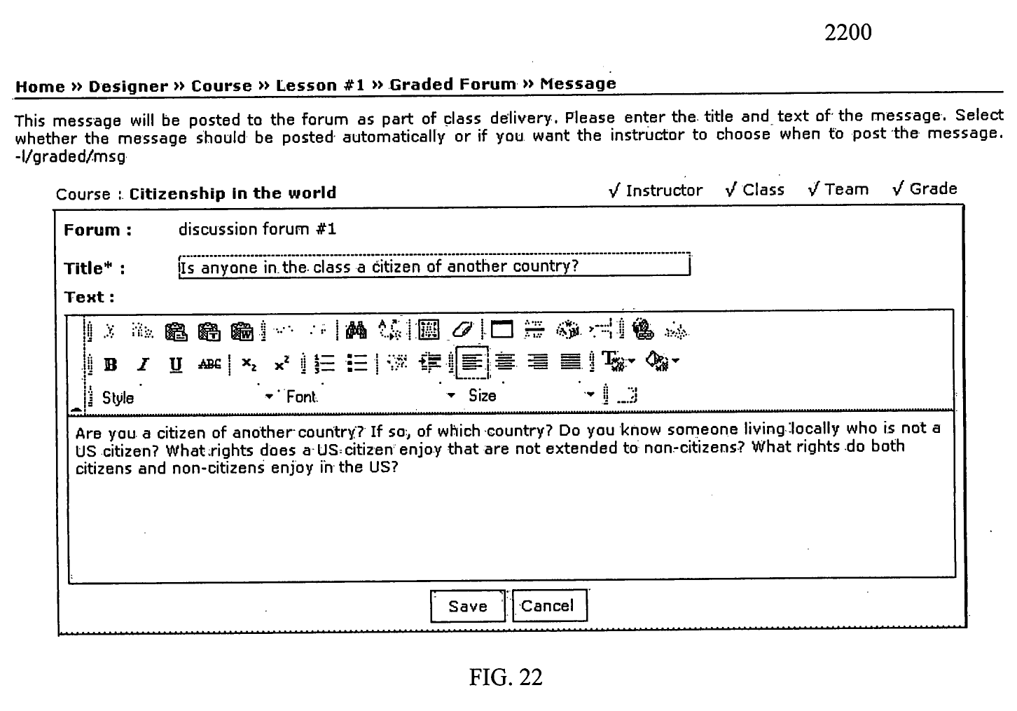

Buttons 2101 preferably allow creation, copying, deletion, and adjustment of messages within the graded forum, as shown in FIG. 21. Links 2103 may preferably be activated to access screen 2200 (FIG. 22), wherein a title and a message content may be provided and/or edited.

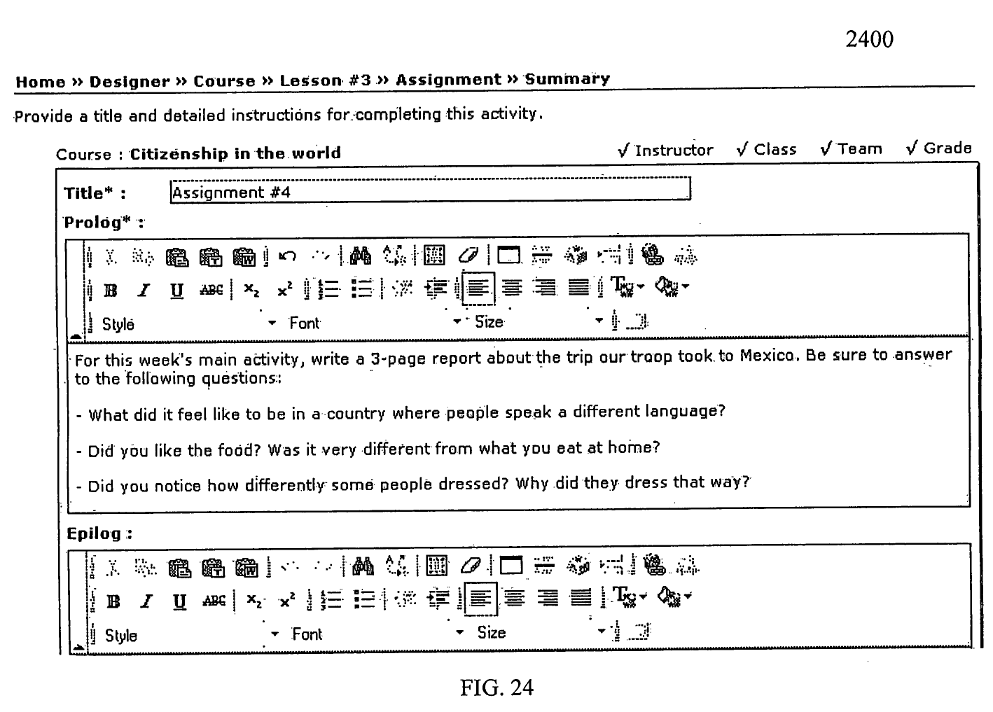

Links 2301, as shown in FIG. 23, preferably allow creation and/or modification of a title, prologue, epilogue, and/or instructor note, analogously to the lesson title, prologue, epilogue, and instructor note discussed above, via screen 2400 of FIG. 24. Link 2303 may preferably be activated to toggle whether work must be submitted (i.e. whether the assignment will have a graded component).

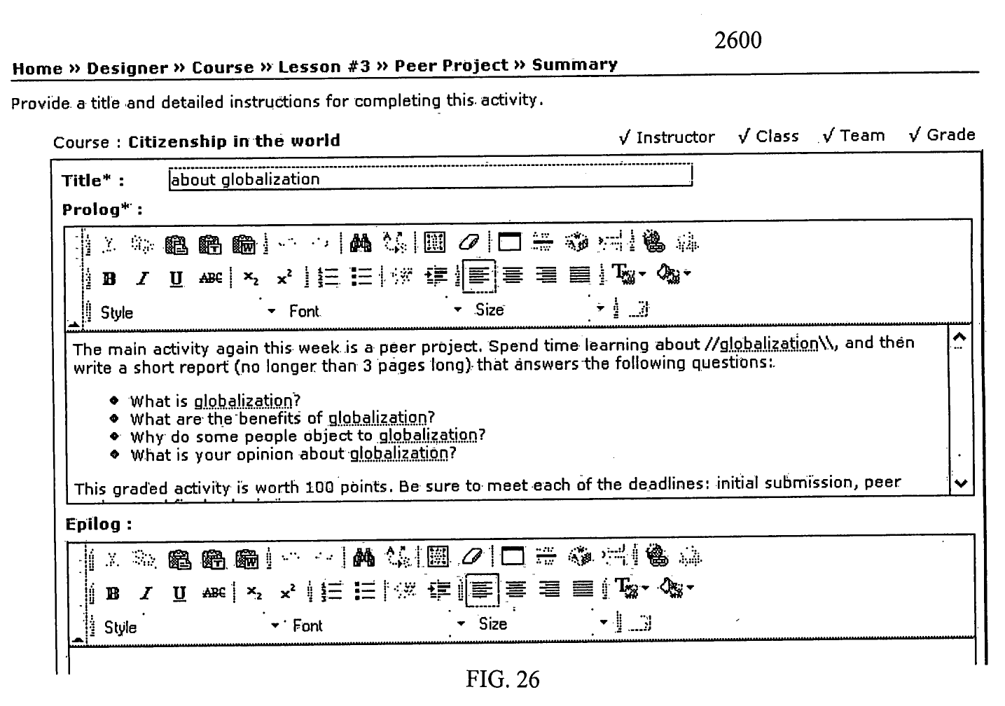

Buttons 2501 preferably allow creation, copying, deletion, and adjustment of messages within the peer project, as shown in FIG. 25. Review questions 2503 may preferably be automatically created by system 100, such as through defaults, and are preferably the same as the assessment criteria used for grading of the project by an instructor. Review questions 2503 may further function as links to adjust the wording of the review question that will be shown to users during review of another students work. Links 2505 may preferably be activated to access screen 2600 (FIG. 26), wherein a title and a message content may be provided and/or edited.

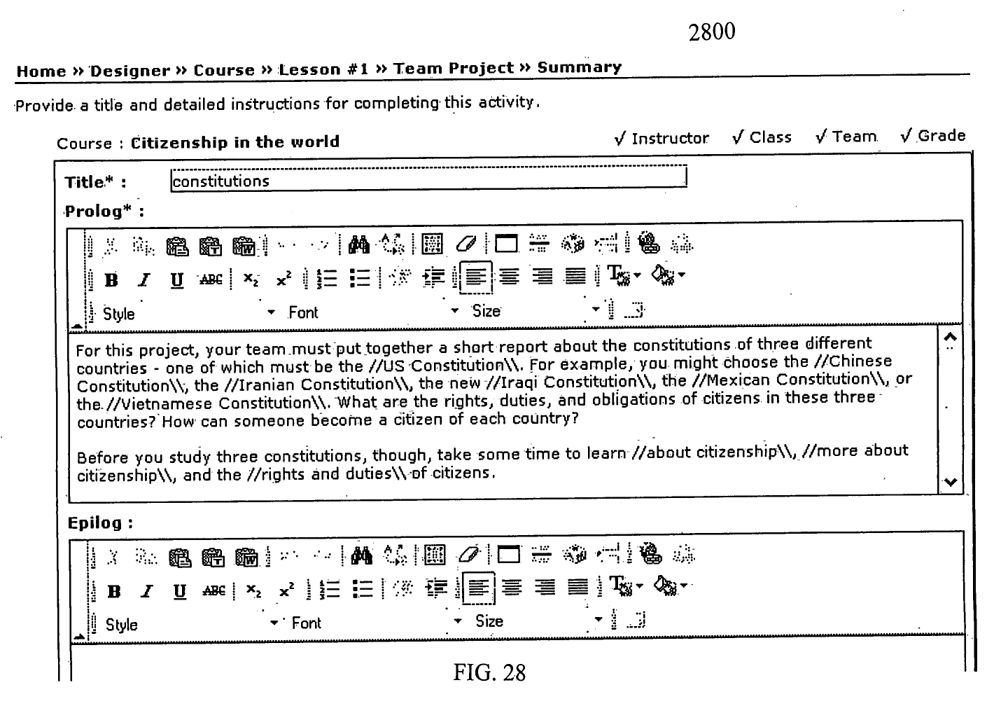

Links 2701, as shown in FIG. 23, preferably allow creation and/or modification of a title, prologue, epilogue, and/or instructor note, analogously to the lesson title, prologue, epilogue, and instructor note discussed above, via screen 2800 of FIG. 28. Link 2703 may preferably be activated to toggle whether work must be submitted (i.e. whether the assignment will have a graded component). Buttons 2705 may preferably be used to adjust the amount of weight assigned to the team member assessments of the other team members. The effect of the assessments, when made, will preferably automatically adjust the grade for each student; thus, changing the weight via buttons 2705 will preferably affect all students in the class.

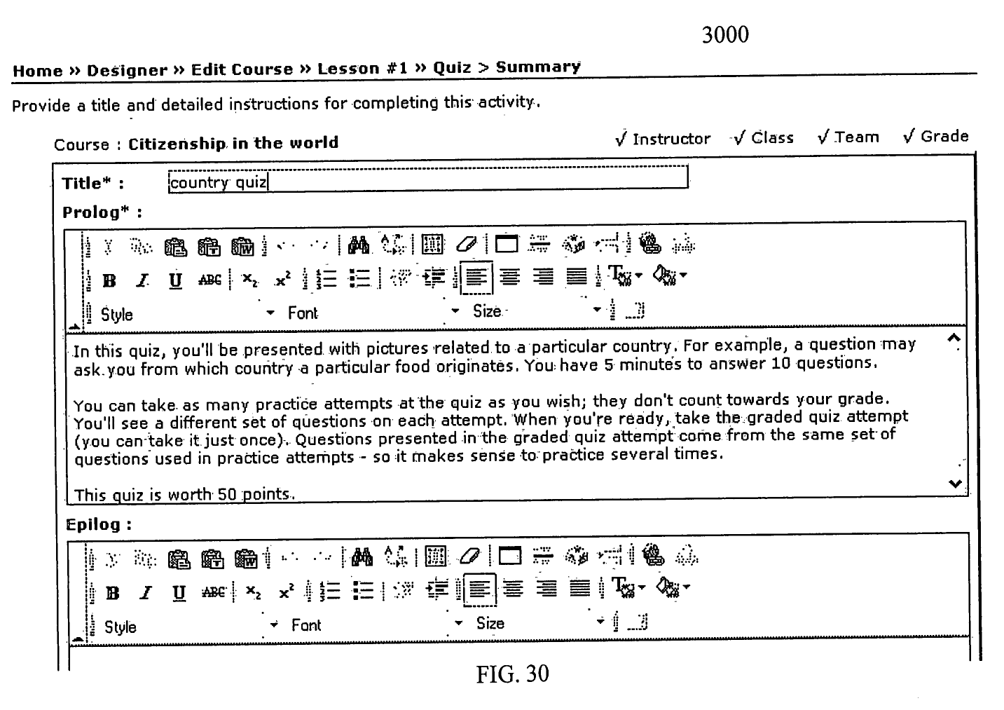

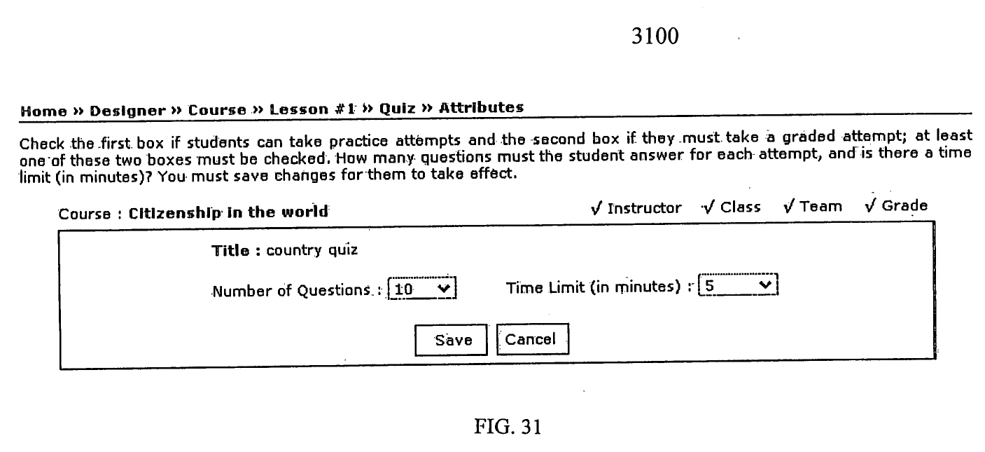

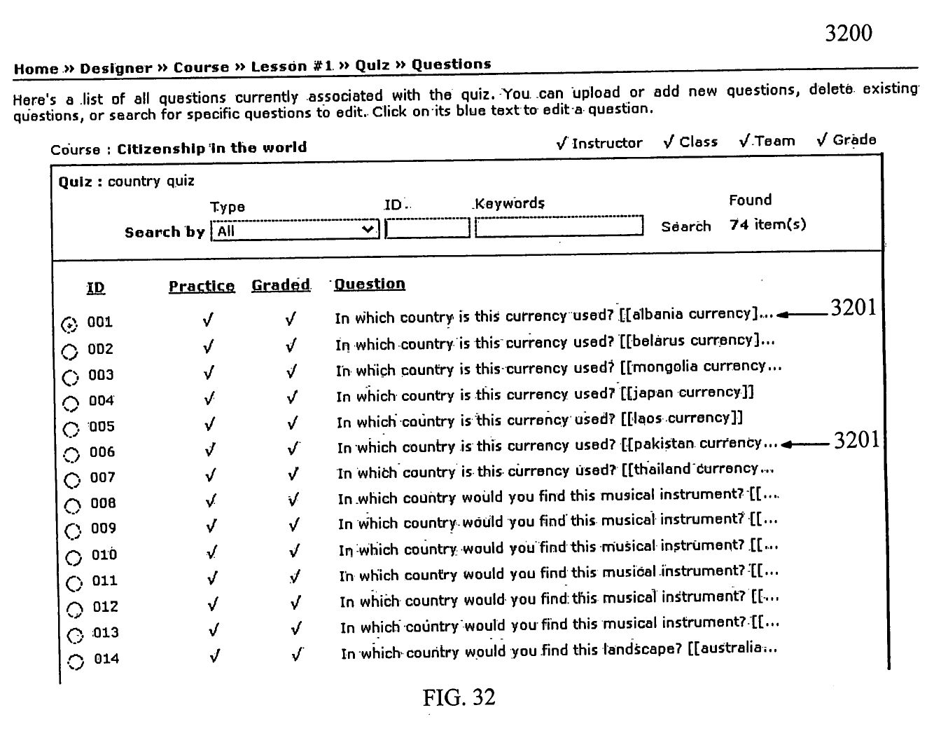

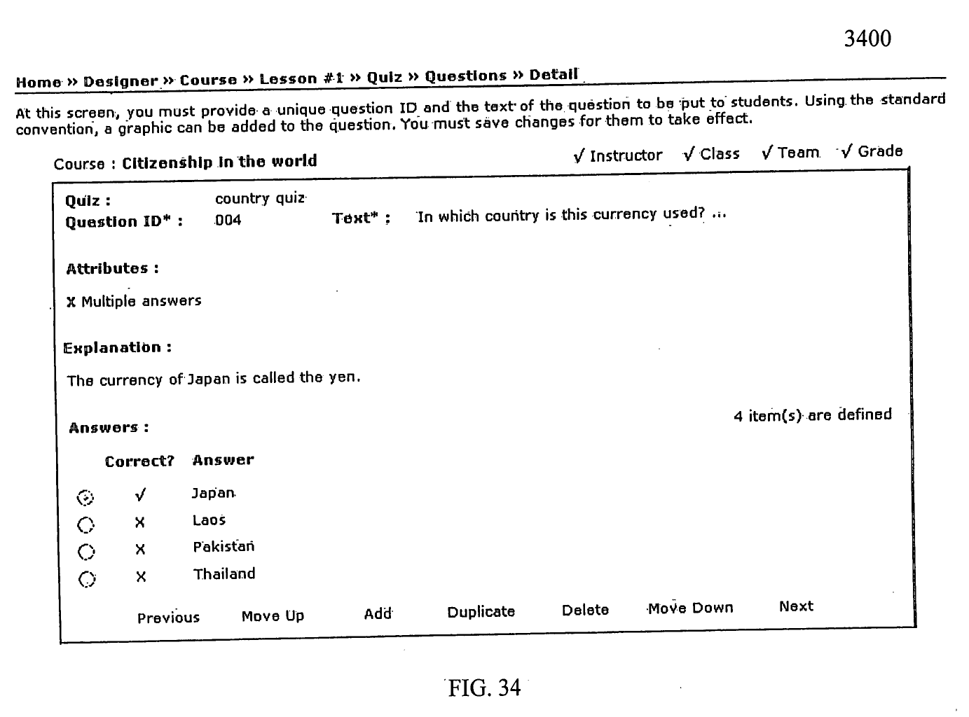

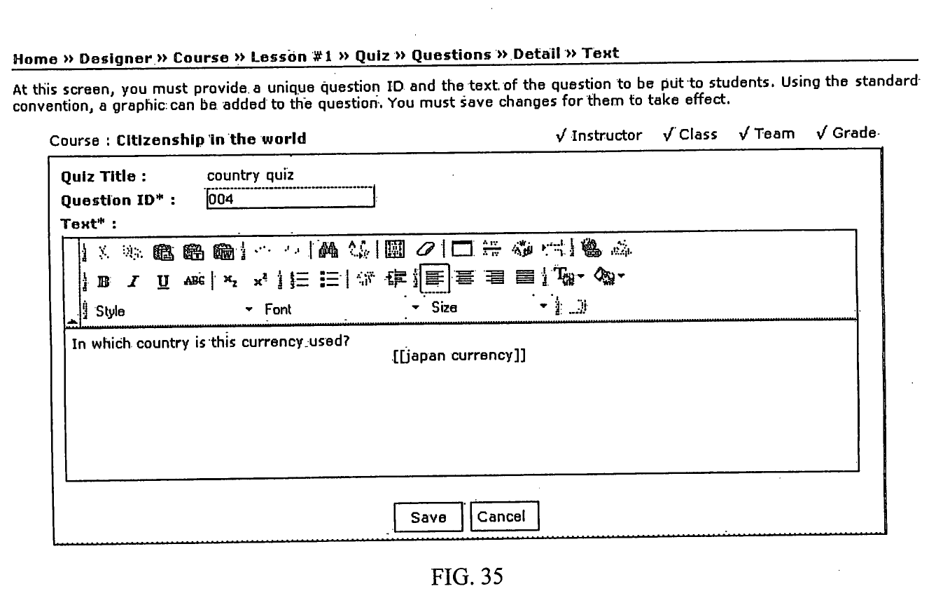

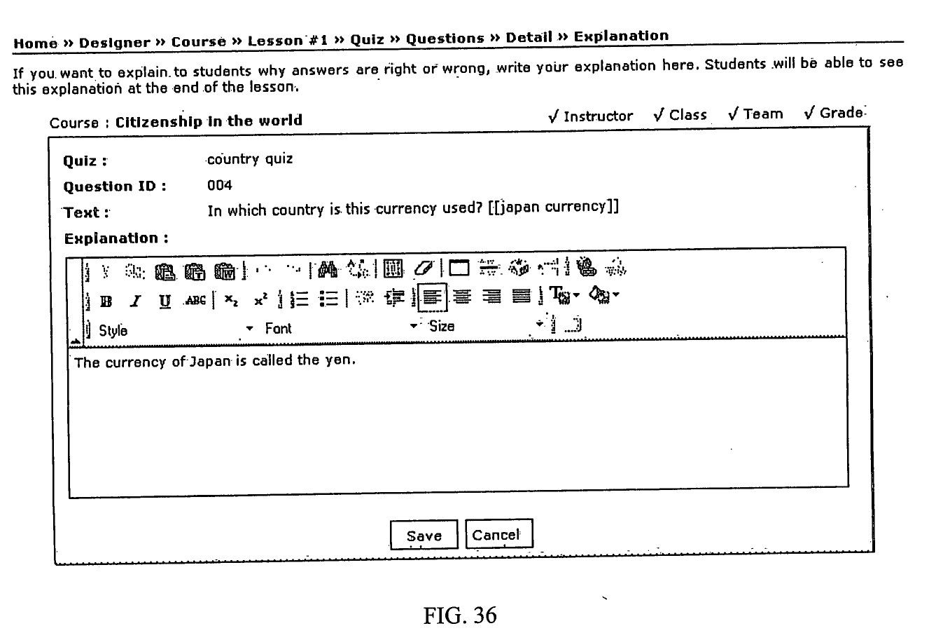

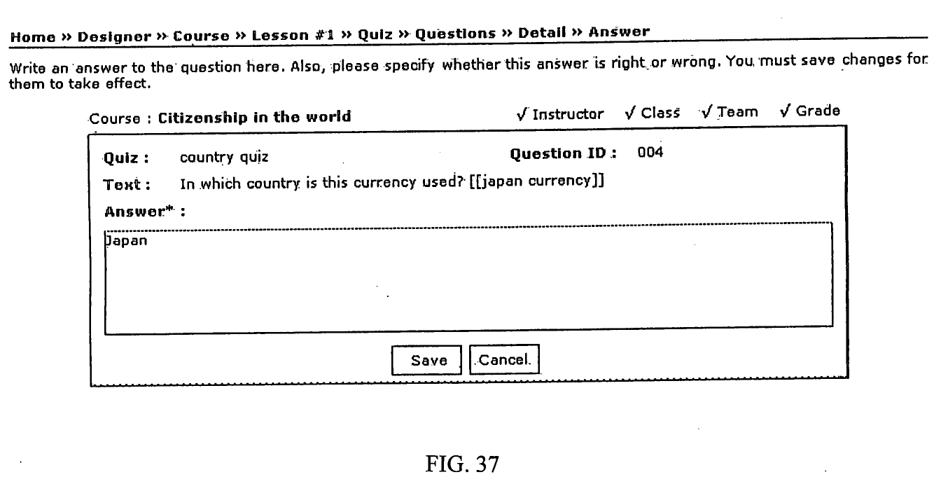

Links 2901, as shown in FIG. 29, preferably allow creation and/or modification of a title, prologue, epilogue, and/or instructor note, analogously to the lesson title, prologue, epilogue, and instructor note discussed above, via screen 3000 of FIG. 30. Buttons 2903 preferably toggle the graded and practice parameters of the quiz. Buttons 2905 and 2907 preferably allow modification of the values associated with the number of questions parameter of the quiz and the time limit parameter of the quiz, respectively, preferably via screen 3100 (FIG. 31). Link 2909 preferably provides access to screen 3200 (FIG. 32), where questions may be added, or modified, such as via one or more buttons, (not shown), and where links 3201 preferably provide access to screen 3400 (FIG. 34) for modification of the question text (FIG. 35), and explanation text (FIG. 36), answer choices (FIG. 37), and a multiple answer parameter (see discussion above with respect to selection of multiple answers) via appropriate links and buttons.

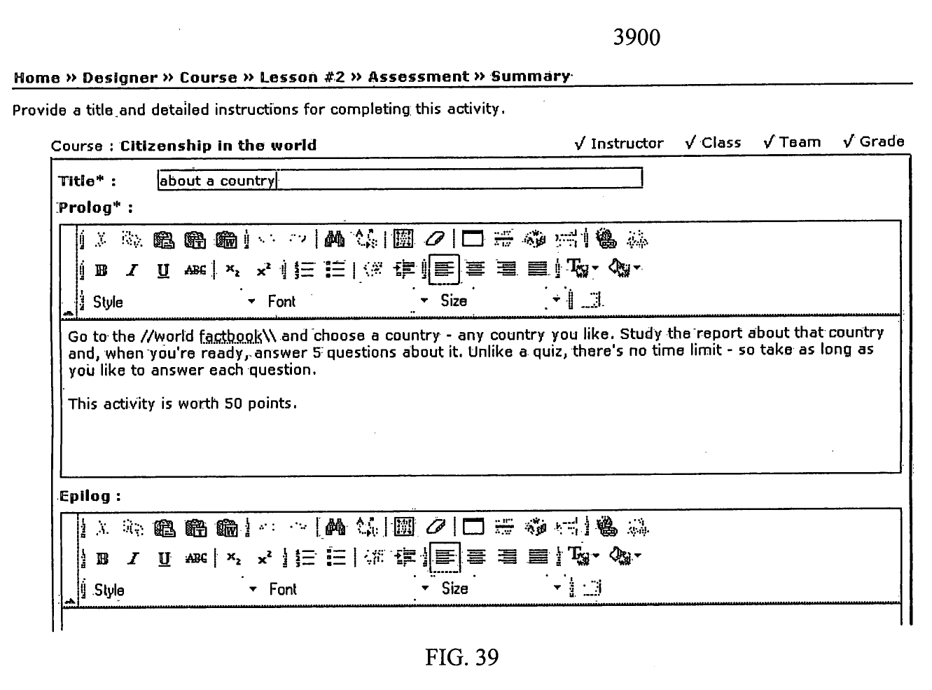

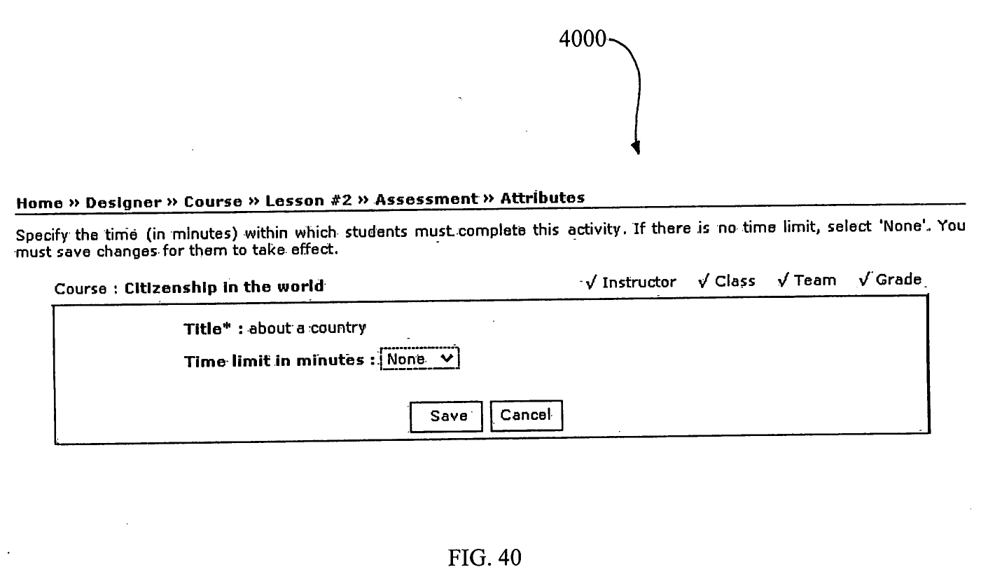

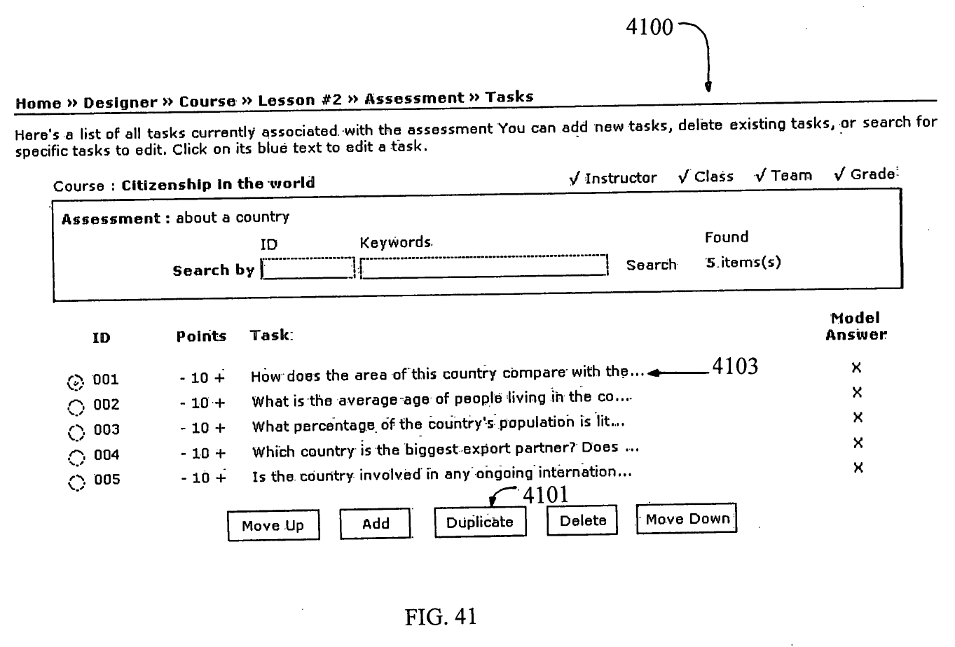

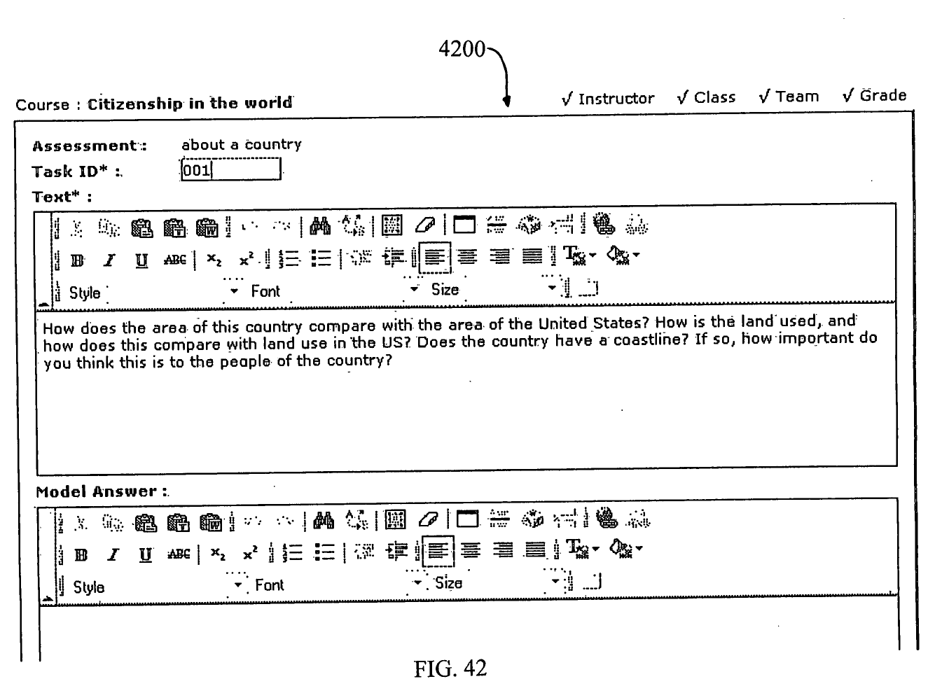

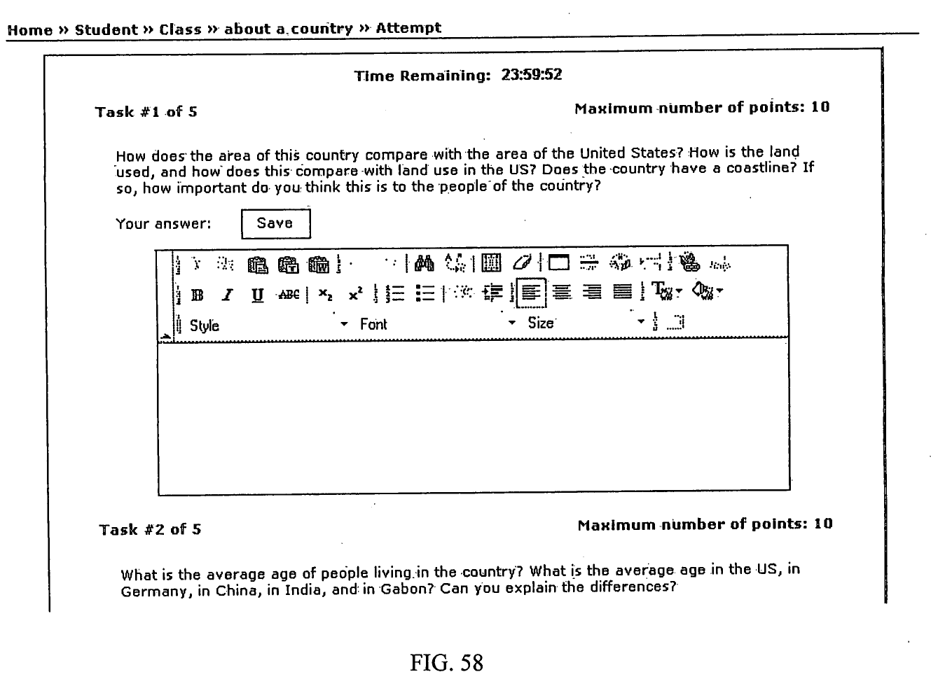

Buttons 3801, as shown in FIG. 38, preferably allow creation and/or modification of a title, prologue, epilogue, and/or instructor note, analogously to the lesson title, prologue, epilogue, and instructor note discussed above, via screen 3900 of FIG. 39. Link 3803 preferably provides access to screen 4000 (FIG. 40) to modify a time limit, or other parameter of the assessment. Link 3805 preferably provides access to screen 4100 (FIG. 41) where tasks may be added, copied, deleted, or adjusted, and where points assigned thereto may be adjusted, each via appropriate buttons 4101, or the like. Links 4103 may preferably provide access to screen 4200 (FIG. 42) where the text of the task, and/or of a model answer, may be modified. FIG. 58 shows a student view of an assessment attempt.

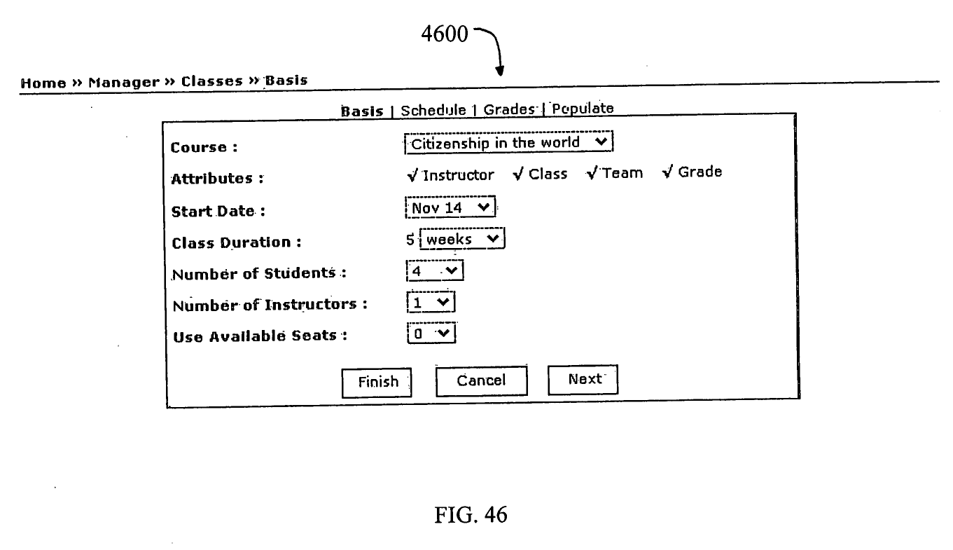

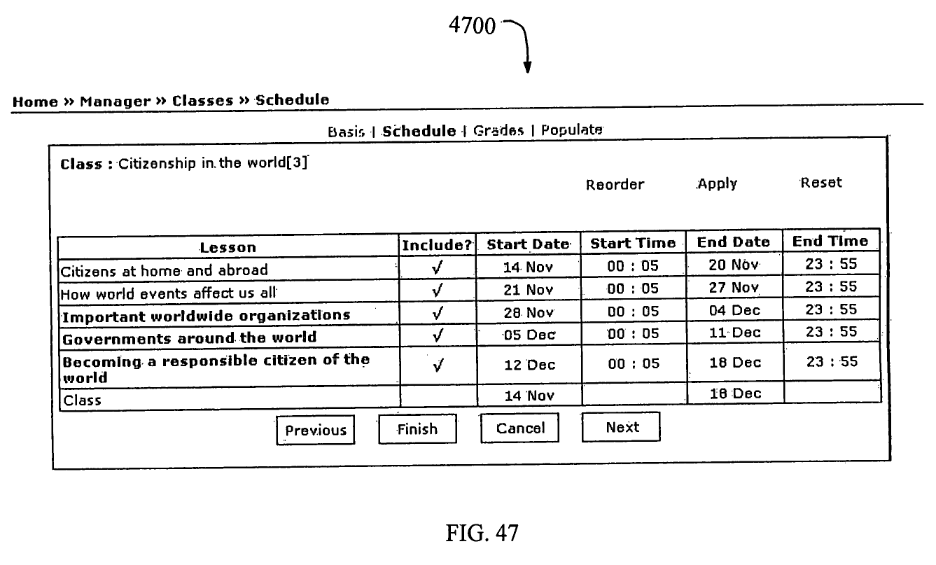

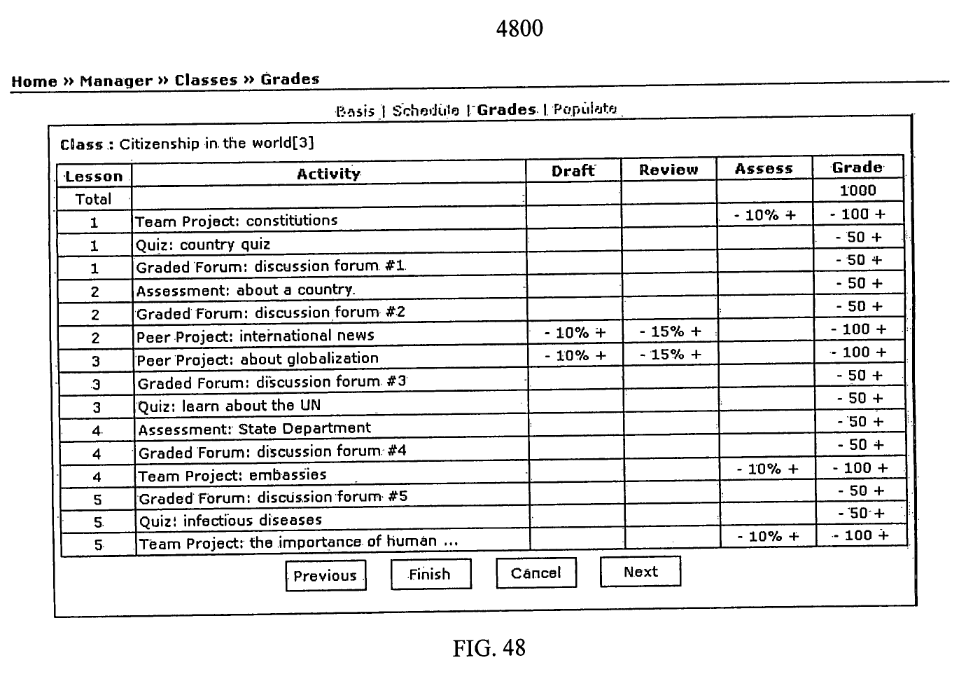

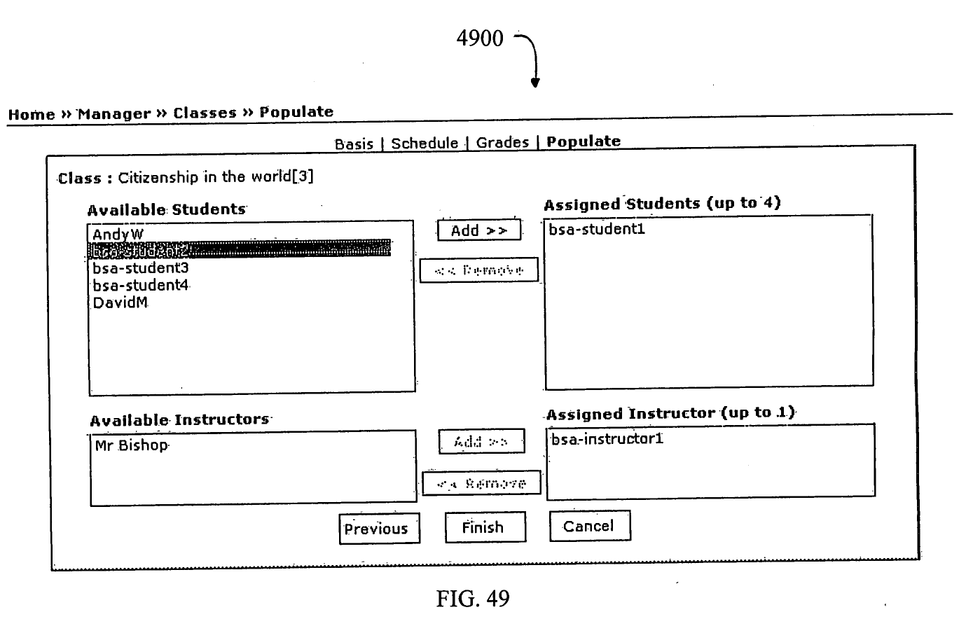

Referring now to FIGS. 46-49, the manager role is illustrated according to a preferred embodiment with respect to class creation. When a user logs on and selects an organization/role combination with a manager role, the user may preferably select whether they wish to access courses (i.e. active and available courses, such as by searching) or classes. If classes are selected, the user may access all currently running, future scheduled, or complete classes, as desired. If a new course creation function is accessed, such as via activation of a button or link, screen 4600 is preferably displayed, where a course, a start date, a class duration, a number of students, a number of instructors, and a number of seats to fill via license or subscription payment arrangement may be selected, such as from a drop-down menu, or other appropriate data entry mechanism. The user may then schedule the class via screen 4700, where start dates, start times, end dates, and end times for all activities of the class are preferably automatically calculated as a default, and may preferably be adjusted, such as via a link, button, or the like. The grade weighting may then be adjusted via screen 4800, as desired, preferably within predefined ranges, i.e. the manager can preferably not remove all grade weights. The user may then populate the class via screen 4900.

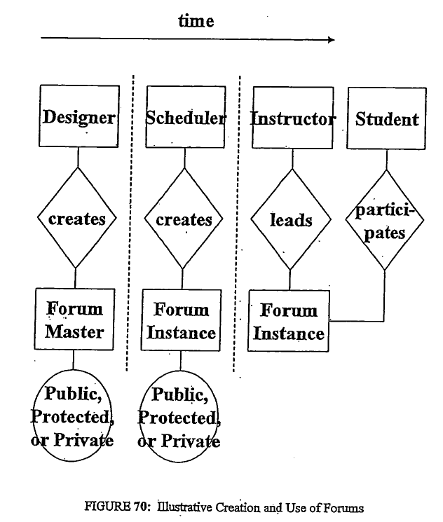

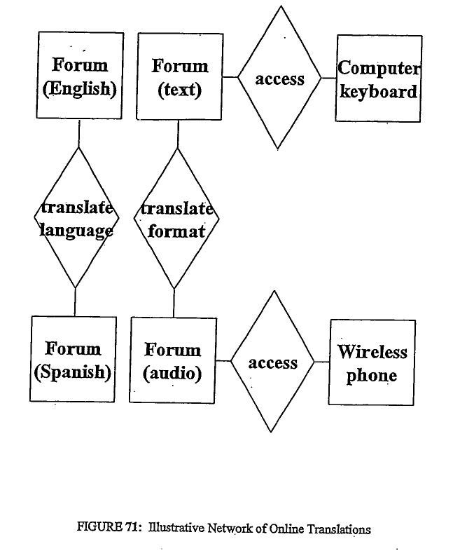

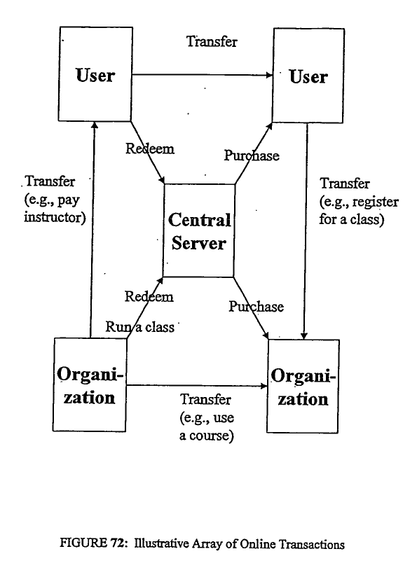

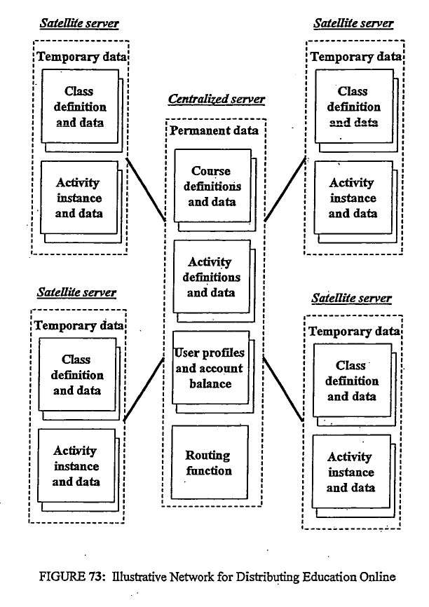

With reference to the foregoing discussion, FIGS. 70-74 illustrate aspects of an exemplary system according to the present invention, detailing optional methods, relationships, sequences and processes.

Having thus described exemplary embodiments of the present invention, it should be noted by those ordinarily skilled in the art that the within disclosures are exemplary only and that various other alternatives, adaptations, and modifications may be made within the scope and spirit of the present invention. For example, while the foregoing description has referred to designers, managers, and students, it will be understood that other different and/or additional roles may be defined. For example, the manager role may be split between a scheduler role and an instructor role, wherein the scheduler sets the specifics of the class during creation, and wherein the instructor participates in the class, such as by leading discussions, reviewing work, assigning grades, or the like. Similarly, the role of the student may take different forms, such as an observer role for parents or other visitors, an auditor role for students not taking the class for a grade, or the like. Additionally, each affiliated organization may have a respective assignment or allocation of permissions for each role, and/or may have different permission assignment or allocation schemes corresponding with different units, divisions, products, programs, or the like. Accordingly, the present invention is not limited to the specific embodiments as illustrated herein, but is only limited by the following claims.

What is claimed is at least:

1. A computer program product stored on a computer readable medium and accessible over a network, for creating a course and offering a class, the computer program product comprising:
(a) a system of predetermined rules for providing at least one of an attribute and a parameter;
(b) a template for creating a course;
(c) said template providing means for adding at least one of a lesson, an activity, and a material to the course;
(d) said template further providing means for assigning at least one of said attribute and parameter to said at least one of lesson, activity, and material.

2. The computer program product of claim 1, further comprising means for creating the class that may be offered to a user thereof by assigning at least one of scheduling information and participant information to an instance of the course.

3. The computer program product of claim 2, wherein said class comprises the instance of said course.

4. The computer program product of claim 2, further comprising means for customizing said at least one of a lesson, an activity, and a material by assigning a predefined attribute to one of said lesson, activity, and material.

5. The computer program product of claim 2, further comprising means for translating at least one of an input and an output between two human languages.

6. The computer program product of claim 2, further comprising means for converting at least one of an input and an output between at least one of an analog and a digital form.

7. The computer program product of claim 6, wherein said means for converting comprises one of file-type conversion, audio-to-text conversion, and text-to-audio conversion.

8. The computer program product of claim 2 further comprising a fee payment system.

9. The computer program product of claim 8, wherein said fees may be charged for access to one of a course and a class.

10. The computer program product of claim 8, wherein said fee payment system comprises electronic tokens as a form of currency.

11. The computer program product of claim 8, wherein said fee payment is associated with offering a class, and is chargeable to an entity offering the class.

12. The computer program product of claim 12, wherein said fee payment is calculated periodically and is determined as a function of a number of students enrolled in a class.

13. The computer program product of claim 1, further comprising means for creating a relationship between a plurality of entities to establish a virtual organization.

14. A system for providing online education, said system comprising:
(a) a plurality of predetermined rules for providing at least one of an attribute and a parameter assignable to at least one of a lesson, an activity, and a material for use in developing a course and offering a class;
(b) a plurality of predetermined and secure operational functions, said operational functions further comprising:
(1) a course designer function;
(2) a class manager function;
(3) a class instructor; and
(4) a class user function;
wherein said system provides secure and predetermined access to said at least one lesson, activity, and material according to each said operational function.

15. A method of creating a class comprising the steps of:
providing a system having at least one predetermined permission for use in creating a course;
using said system to create a course;
creating a class, said class comprising an instance of said course.
